(19) United States
(12) Patent Application Publication
(10) Pub. No.: US 2026/0311031 A1
(43) Pub. Date: Oct. 8, 2026

(54) COMPACT GRAPH-BASED PULSE DESCRIPTION FOR CONTROLLING QUANTUM COMPUTERS

(71) Applicant: Duke University, Durham, NC (US)

(72) Inventors: Kenneth Ray Brown, Durham, NC (US); Leon Riesebos, Durham, NC (US); Aniket Dalvi, Durham, NC (US)

(21) Appl. No.: 19/479,025

(22) PCT Filed: Apr. 25, 2024
(86) PCT No.: PCT/US2024/026194

§ 371 Date: Oct. 27, 2025

Related U.S. Application Data
(60) Provisional application No. 63/462,599, filed on Apr. 28, 2023.

(51) Int. Cl. G06N 10/80; G06N 10/40

(52) U.S. Cl. CPC G06N 10/80; G06N 10/40

(57) ABSTRACT

Technologies for providing pulse-level access in a quantum computing system based on a graph-based architecture include a compute device with circuitry configured to obtain pulse description data indicative of a graph representing one or more parameters of at least one waveform that defines at least one pulse. The circuitry may also be configured to perform analysis operations on the graph to determine properties of the at least one pulse and produce a corresponding target pulse description based on the analysis. The circuitry may be additionally configured to provide the target pulse description to a target application to produce the at least one pulse.

### CROSS-REFERENCE TO RELATED APPLICATION

This application claims the benefit, under 35 U.S.C. § 119 (e), of U.S. Provisional Patent Application No. 63/462,599, filed Apr. 28, 2023, the entirety of which is hereby expressly incorporated by reference herein.

### GOVERNMENT LICENSE RIGHTS

This invention was made with government support under 1832377, awarded by the National Science Foundation (NSF). The government has certain rights in the invention.

### FIELD

The present disclosure generally relates to quantum computing, and more specifically to techniques for providing pulse-level access in a quantum computing system based on a graph-based architecture.

### BACKGROUND

Programming quantum computing systems at the pulse-level (e.g., radio frequency (RF) signal-level) enables users to experiment with new pulse shapes, express low-level calibration, and optimize quantum applications beyond a discrete gate model. Generally, application programming interfaces (API) that enable pulse-level access provide a thin abstraction layer between the API and the RF equipment such that a programmer does not have to know the details of the RF equipment. However, existing pulse-level programming methods are quantum-technology specific, RF-hardware specific, or not integrated into classically universal kernels. For example, some APIs primarily target a specific type of quantum system, like a superconducting quantum computer or an ion trap computer, and only provide support for discrete quantum operations but no support for classical operations (i.e., operations performed by the processor and memory accompanying the quantum computing equipment, such as arithmetic and control flow operations). Other examples of APIs use specific models, like a sample-based model, and those APIs target specific RF equipment (e.g., arbitrary waveform generators).

Creating an API for pulse-level access poses several challenges to consider. For instance, sample-based approaches, such as the model alluded to above, can characterize arbitrary pulses but have a low information density and are not target-independent. Further, pulses that are transformed into samples lose high-level information about the original waveform, such as the frequencies in the signal. Directly storing high-level pulse data, such as frequencies and phases, often leads to inflexible solutions that do not adapt to complex pulse shapes and modulation techniques.

### SUMMARY

According to one aspect of the disclosure, a compute device includes circuitry configured to obtain pulse description data indicative of a graph representing one or more parameters of at least one waveform that defines at least one pulse. The circuitry may also be configured to perform analysis operations on the graph to determine properties of the at least one pulse and produce a corresponding target pulse description based on the analysis. Additionally, the circuitry may be configured to provide the target pulse description to a target application to produce the at least one pulse.

In some embodiments, obtaining pulse description data includes obtaining pulse description data indicative of a directed acyclic graph of nodes and edges between the nodes. Further, obtaining pulse description data indicative of a directed acyclic graph may include obtaining a directed acyclic graph with one or more regular nodes with labeled parameters and relations represented by labeled directed edges. The circuitry may be configured such that obtaining pulse description data indicative of a directed acyclic graph includes obtaining a directed acyclic graph with one or more operator nodes with an ordered set of items and relations represented by enumerated directed edges. In some embodiments, obtaining pulse description data indicative of a directed acyclic graph includes obtaining a directed acyclic graph with at least one node that represents a scalar.

The circuitry may be configured such that obtaining pulse description data indicative of a directed acyclic graph includes obtaining a directed acyclic graph with at least one node that represents a waveform. Further, obtaining a directed acyclic graph with at least one node that represents a waveform may include obtaining a directed acyclic graph with a waveform node that has one or more sub-nodes indicative of parameters of the waveform. The circuitry may be configured to obtain data indicative of a waveform parameter that is a scalar or a waveform. In some embodiments, obtaining pulse description data indicative of a directed acyclic graph includes obtaining a directed acyclic graph with at least one variable node that represents a variable that is not defined at the time the graph is constructed. The circuitry of the compute device may be configured such that obtaining pulse description data includes obtaining pulse description data in which waveforms are assigned to channels in a schedule.

In some embodiments, obtaining pulse description data in which waveforms are assigned to channels in a schedule includes obtaining pulse description data in which waveforms are assigned to channels that represent analog output devices. The circuitry may be configured such that performing analysis operations on the graph includes substituting at least one variable represented by a node of the graph with a defined value. Substituting at least one variable may include utilizing a key-value mapping to map a value to a key associated with the variable. The circuitry of the compute device may be configured such that substituting at least one variable includes substituting variables with pulse parameterization or calibration parameters after construction of the graph. The circuitry may be configured such that performing analysis operations on the graph includes performing graph traversal operations. Performing graph traversal operations may include performing maximal munch operations.

In some embodiments, the circuitry may be configured such that performing graph traversal operations includes recursively traversing the graph and executing a visit function of a visitor class for each node of multiple nodes of the graph. Performing graph traversal operations may include performing graph transformation operations. The circuitry may be configured to perform graph transformation operations by utilizing a transformer class. Performing graph transformation operations, in some embodiments, may include performing graph simplification or graph formatting operations to obtain a target graph shape. Performing graph traversal operations, in some embodiments, may include performing at least one verification operation. The circuitry may be configured such that performing at least one verification operation includes performing a graph validity check or a graph content check. Performing graph traversal operations may include utilizing a pipeline of visitors to perform the graph traversal operations. The circuitry may be further configured to render at least one pulse sample. In some embodiments, the circuitry may be configured such that performing analysis operations on the graph includes providing high-level data associated with the at least one pulse. Providing high-level data may include providing data indicative of a frequency, a frequency modulation, a duration, a phase, or a phase modulation of at least one waveform defining the at least one pulse.

In some embodiments, the circuitry may be configured such that providing the target pulse description to the target application includes providing at least one pulse sample to the target application. Providing the target pulse description to the target application, in some embodiments, may include providing a schedule that maps waveforms to channels associated with corresponding output devices. In some embodiments, the circuitry may be configured such that providing the target pulse description to the target application includes providing direct digital synthesis parameters to the target application. Providing the target pulse description to the target application may include providing the target pulse description to a control system. The circuitry may be configured such that providing the target pulse description to a control system includes providing the target pulse description to a radio frequency (RF) controller. In some embodiments, providing the target pulse description to an RF controller includes providing the target pulse description to an RF controller of a quantum system. The circuitry may be configured such that providing the target pulse description to an RF controller of a quantum system includes providing the target pulse description to an RF controller of an ion trap quantum computer system. The circuitry of the compute device may be configured such that providing the target pulse description to a target application includes providing the target pulse description to a simulator.

In another aspect of the disclosure, a method includes obtaining, by a compute device, pulse description data indicative of a graph representing one or more parameters of at least one waveform that defines at least one pulse. The method may also include performing, by the compute device, analysis operations on the graph to determine properties of the at least one pulse and produce a corresponding target pulse description based on the analysis. Additionally, the method may include providing, by the compute device, the target pulse description to a target application. In some embodiments, obtaining pulse description data comprises obtaining pulse description data indicative of a directed acyclic graph of nodes and edges between the nodes. Obtaining pulse description data indicative of a directed acyclic graph may include obtaining a directed acyclic graph with one or more regular nodes with labeled parameters and relations represented by labeled directed edges. In some embodiments, obtaining pulse description data indicative of a directed acyclic graph includes obtaining a directed acyclic graph with one or more operator nodes with an ordered set of items and relations represented by enumerated directed edges.

Obtaining pulse description data indicative of a directed acyclic graph, in some embodiments of the method, includes obtaining a directed acyclic graph with at least one node that represents a scalar. In some embodiments, obtaining pulse description data indicative of a directed acyclic graph includes obtaining a directed acyclic graph with at least one node that represents a waveform. Obtaining a directed acyclic graph with at least one node that represents a waveform may include obtaining a directed acyclic graph with a waveform node that has one or more sub-nodes indicative of parameters of the waveform. The method may also include obtaining, by the compute device, data indicative of a waveform parameter that is a scalar or a waveform.

Obtaining pulse description data indicative of a directed acyclic graph may include obtaining a directed acyclic graph with at least one variable node that represents a variable that is not defined at the time the graph is constructed. In some embodiments, obtaining pulse description data includes obtaining pulse description data in which waveforms are assigned to channels in a schedule. Obtaining pulse description data in which waveforms are assigned to channels in a schedule may include obtaining pulse description data in which waveforms are assigned to channels that represent analog output devices.

Performing analysis operations on the graph may include substituting at least one variable represented by a node of the graph with a defined value. Substituting at least one variable may include utilizing a key-value mapping to map a value to a key associated with the variable. In some embodiments, substituting at least one variable comprises substituting variables with pulse parameterization or calibration parameters after construction of the graph. Performing analysis operations on the graph, in some embodiments, may include performing graph traversal operations, which may include performing maximal munch operations. In some embodiments, performing graph traversal operations includes recursively traversing the graph and executing a visit function of a visitor class for each node of multiple nodes of the graph.

Performing graph traversal operations may include performing graph transformation operations, which may include utilizing a transformer class. In some embodiments, performing graph transformation operations includes performing graph simplification or graph formatting to obtain a target graph shape. Performing graph traversal operations may include performing at least one verification operation, which may include a graph validity check or a graph content check. In some embodiments, performing graph traversal operations may include utilizing a pipeline of visitors to perform the graph traversal operations. The method may also include rendering, by the compute device, at least one pulse sample.

Performing analysis operations on the graph may include providing high-level data associated with the at least one pulse. In some embodiments, providing high-level data includes providing data indicative of a frequency, a frequency modulation, a duration, a phase, or a phase modulation of at least one waveform defining the at least one pulse. In some embodiments, providing the target pulse description to the target application includes providing at least one pulse sample to the target application. Providing the target pulse description to the target application may include providing a schedule that maps waveforms to channels associated with corresponding output devices. In some embodiments, providing the target pulse description to the target application includes providing direct digital synthesis parameters to the target application.

Providing the target pulse description to the target application may include providing the target pulse description to a control system. In some embodiments, providing the target pulse description to a control system includes providing the target pulse description to a radio frequency (RF) controller. Providing the target pulse description to an RF controller may include providing the target pulse description to an RF controller of a quantum system, which in some embodiments, may be an RF controller of an ion trap quantum computer system. In some embodiments, providing the target pulse description to a target application involves providing the target pulse description to a simulator.

In yet another aspect of the present disclosure, one or more machine-readable storage media may include a set of instructions stored thereon that, when executed by a system having one or more compute devices, cause the one or more compute devices of the system to perform any of the methods described above.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for providing a graph-based pulse-level programming framework for use in a target application;

FIG. 2 is a simplified block diagram of at least one embodiment of a compute device of the system of FIG. 1;

FIG. 3 is a partial view of an example ion trap quantum computer configured to provide a pulse-level programming framework for quantum computing applications, according to an embodiment;

FIGS. 4-6 are flowcharts of at least one embodiment of a method for providing a graph-based pulse-level programming framework for use in a target application that may be implemented by the system of FIG. 1;

FIG. 7 is a diagram of at least one embodiment of a workflow that may be implemented with the system of FIG. 1;

FIG. 8 is a table of scalar operators and their properties that may be utilized in at least one embodiment of the system of FIG. 1;

FIG. 9 is a diagram of a directed acyclic graph for the sum of a number and a variable that may be utilized in at least one embodiment of the system of FIG. 1;

FIG. 10 is a table of waveforms and parameters that may be utilized in at least one embodiment of the system of FIG. 1;

FIG. 11 is a diagram of a directed acyclic graph of a constant waveform with a scalar value and a scalar duration that may be utilized in at least one embodiment of the system of FIG. 1;

FIG. 12 is a diagram of a directed acyclic graph of a sine waveform with a static frequency and phase that may be utilized in at least one embodiment of the system of FIG. 1;

FIG. 13 is a diagram of a directed acyclic graph of a sine waveform with a triangle modulated frequency that may be utilized in at least one embodiment of the system of FIG. 1;

FIG. 14 is a graph of a rendered triangle waveform associated with the directed acyclic graph of FIG. 13;

FIG. 15 is a graph of a rendered sine waveform with a triangle modulated frequency;

FIG. 16 is a diagram of a directed acyclic graph with a frequency modulated waveform and Gaussian amplitude modulation that may be utilized in at least one embodiment of the system of FIG. 1;

FIG. 17 is a graph of a rendered sine waveform with frequency and amplitude modulation based on the acyclic directed graph of FIG. 16;

FIG. 18 is a table of waveform operator and their properties that may be utilized in at least one embodiment of the system of FIG. 1;

FIG. 19 is a diagram of two directed acyclic graphs representing absolute and continuous phase modes that may be utilized in at least one embodiment of the system of FIG. 1;

FIG. 20 is a is a graph of rendered sine waveforms based on the directed acyclic graphs of FIG. 19;

FIG. 21 is a diagram of a directed acyclic graph of a frequency modulated sine waveform based on a 10 MHz carrier frequency that may be utilized in at least one embodiment of the system of FIG. 1;

FIG. 22 is a diagram of a directed acyclic graph representing the waveform associated with FIG. 21 in an expanded form that may be utilized in at least one embodiment of the system of FIG. 1;

FIG. 23 is a schematic of a front end and pipeline that may be utilized by the system of FIG. 1 to generate a target pulse description;

FIG. 24 is a class diagram of nodes, scalars, and waveforms that may be utilized in at least some embodiments of the system of FIG. 1;

FIG. 25 is a table of a method resolution order for scalar and waveform classes that may be utilized in at least some embodiments of the system of FIG. 1;

FIG. 26 is a diagram of two directed acyclic graphs associated with utilizing an operator on a scalar or a waveform with implicit type promotion that may be utilized in at least some embodiments of the system of FIG. 1;

FIG. 27 is a graph of a rendered waveform that may be generated based on a schedule in at least one embodiment of the system of FIG. 1;

FIG. 28 is a diagram of an embodiment of the system of FIG. 1 in which a target application is a simulator; and

FIG. 29 is a diagram of an embodiment of the system of FIG. 1 in which the target application is a quantum control system.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

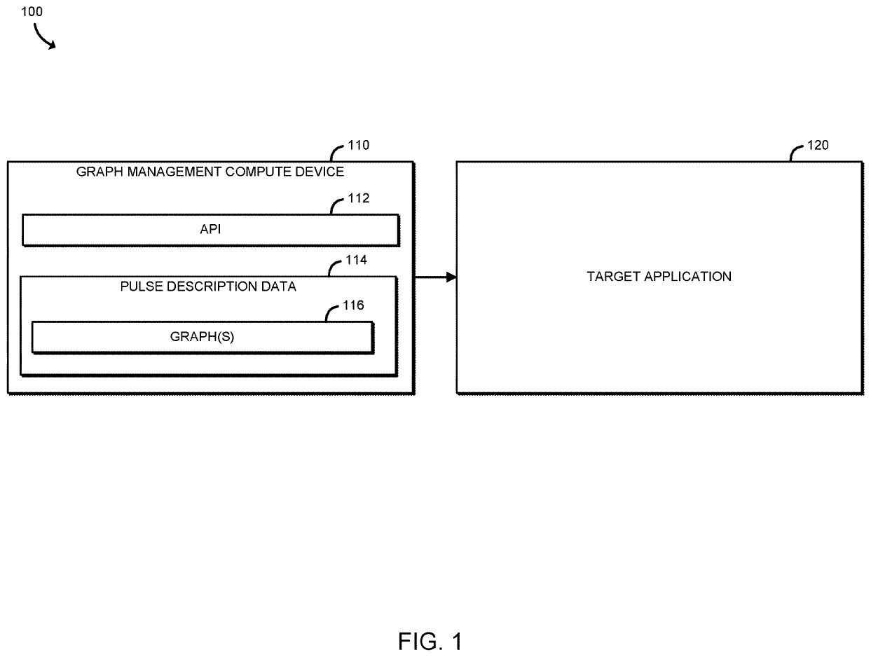

Referring now to FIG. 1, a system 100 for providing a graph-based pulse-level programming framework includes, in the illustrative embodiment, a graph management compute device 110 that, in operation, provides an output (e.g., a target pulse description, as described in more detail herein) to a target application 120. In the illustrative embodiment, the graph management compute device 110 utilizes an application programming interface 112 (API) that enables the management (e.g., creation, modification, analysis, and the like) of pulse description data (e.g., data that defines a pulse, such as a finite duration pulse formed by one or more waveforms) 114 using graphs 116 (e.g., a data structure in which nodes are connected by edges). More specifically, the graph-based architecture may be a directed acyclic graph (DAG) structure that enables compact pulse descriptions and retains high-level information on complex pulses and modulation schemes and phase synchronization information for pulses using operator nodes. The DAG structure may also include variable nodes to provide pulse parameterization and insertion of calibration parameters. That is, the values of the variable nodes can be substituted after graph construction. Further, the DAG structure, in the illustrative embodiment, includes infrastructure for pulse schedules using channels. Using the DAG structure for pulse descriptions further allows for recursive graph algorithms to carry out pulse analysis and transformations, even before variables are substituted. Further, pulse properties can be extracted from the graph on a high abstraction level using graph algorithms (e.g., maximal munch).

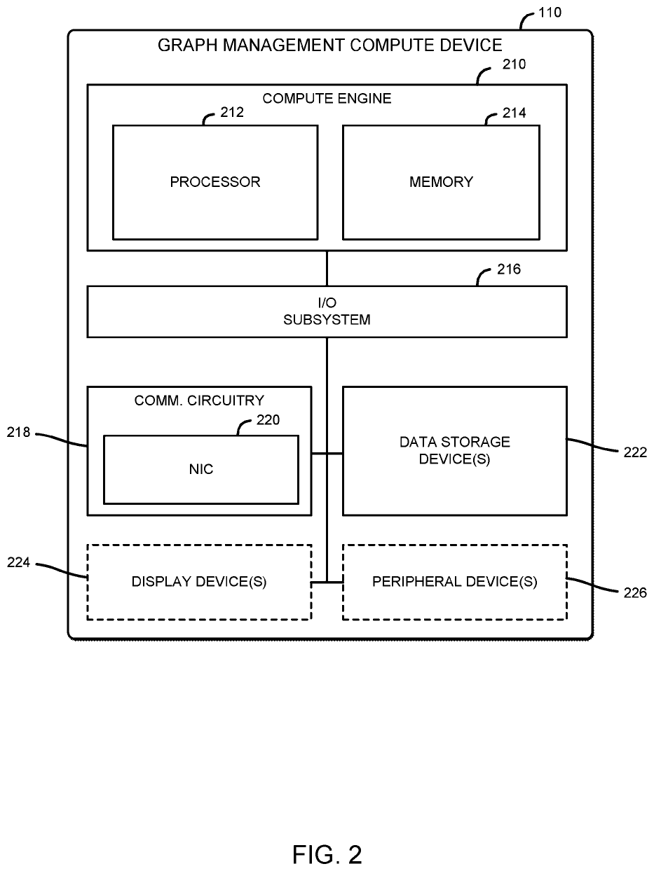

Referring now to FIG. 2, the illustrative graph management compute device 110 includes a compute engine 210, an input/output (I/O) subsystem 216, communication circuitry 218, and one or more data storage devices 222. In some embodiments, the graph management compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the graph management compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as graphs, graph manipulation and analysis functions, applications, libraries, and drivers.

The compute engine 210 is communicatively coupled to other components of the graph management compute device 110 via the I/O subsystem 216, which may be embodied as circuitry and/or components to facilitate input/output operations with the compute engine 210 (e.g., with the processor 212 and the main memory 214) and other components of the graph management compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the graph management compute device 110, into the compute engine 210.

The communication circuitry 218 may be embodied as any communication circuit, device, or collection thereof, capable of enabling communications (e.g., over a network or other communication link) between the graph management compute device 110 and another device (e.g., a compute device associated with the target application 120). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the graph management compute device 110 to connect with another compute device (e.g., a compute device associated with the target application 120 etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the graph management compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the graph management compute device 110 are housed in a single unit. However, in other embodiments, the components may be in separate housings, in separate racks of a data center, and/or spread across multiple data centers or other facilities. It should be appreciated that the graph management compute device 110 may include other components, sub-components, and devices commonly found in a computing device, which are not discussed above in reference to the graph management compute device 110 and not discussed herein for clarity of the description.

Referring back to FIG. 1, advantageously, the API 112 and underlying architecture are different from conventional systems for a variety of reasons. For example, the API 112 and associated architecture may be adapted to a variety of target applications 120 that may receive data defining a pulse as an input (e.g., a quantum computing system with RF equipment, RADAR, or other applications), as the architecture is technology-agnostic, target independent, and relatively easy for a programmer to parameterize or transform. Additionally, and as described herein, the architecture enables analysis and/or transformation of pulse descriptions before all parameters are concrete (e.g., defined). Further, the architecture enables integration of pulse-level control into a programming environment that also enables universal classical operations and discrete quantum operations.

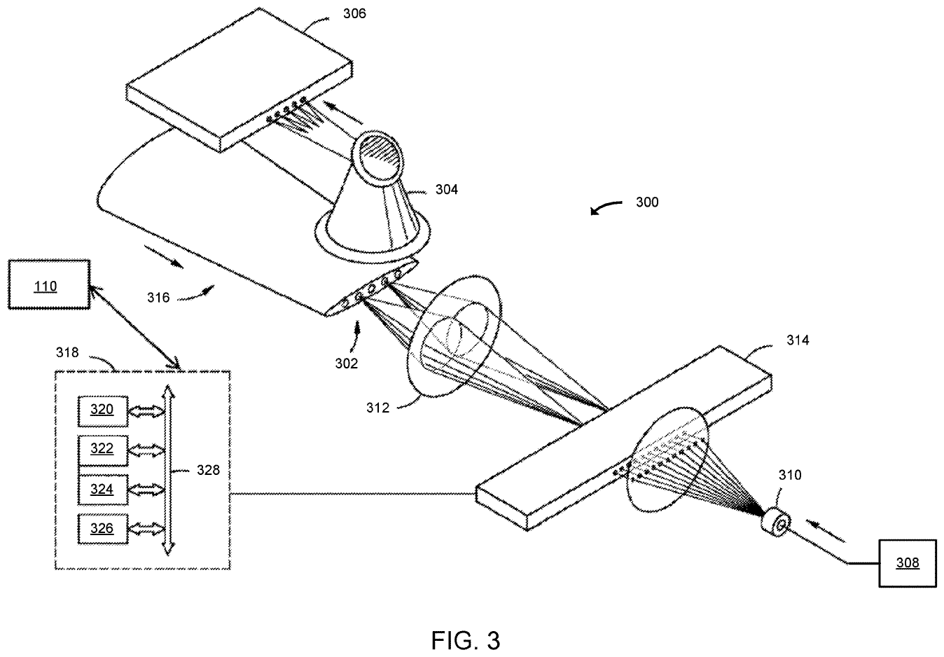

FIG. 3 provides a partial view of an example ion trap quantum computer, or system 300, that may implement the pulse-level programming framework described herein (e.g., as a target application 120), according to one embodiment. That is, the system 300 is an embodiment of the target application 120 from FIG. 1. The system 300 includes a system controller 318 and a quantum register that is a chain 302 of trapped ions (i.e., five shown) that extend along the Z-axis. An imaging objective 304, such as an objective lens with a numerical aperture (NA), for example, of 0.37, collects fluorescence along the Y-axis from the ions and maps each ion onto a multi-channel photo-multiplier tube (PMT) 306 for measurement of individual ions. Non-copropagating Raman laser beams from a laser 308, which are provided along the X-axis, perform operations on the ions. A diffractive beam splitter 310 creates an array of static Raman beams 312 that are individually switched using a multi-channel acousto-optic modulator (AOM) 314 and is configured to selectively act on individual ions. A global Raman laser beam 316 illuminates all ions at once.

The system controller (also referred to as a “RF controller”) 318 controls the AOM 314. The system controller 318 includes a central processing unit (CPU) 320, a read-only memory (ROM) 322, a random access memory (RAM) 324, a storage unit 326, and the like. The CPU 320 is a processor of the RF controller 318. The ROM 322 stores various programs and the RAM 324 is the working memory for various programs and data. The storage unit 326 includes a nonvolatile memory, such as a hard disk drive (HDD) or a flash memory, and stores various programs even if power is turned off. The CPU 320, the ROM 322, the RAM 324, and the storage unit 326 are interconnected via a bus 328.

The RF controller 318 executes a control program which is stored in the ROM 322 or the storage unit 326 and uses the RAM 324 as a working area. The control program will include software applications that include program code that may be executed by the processor in order to perform various functionalities associated with receiving and analyzing data and controlling the ion trap quantum computer system 300. In the illustrative embodiment, the control program may include program code for receiving a target pulse description produced by the graph management compute device 110 and controlling the AOM 314 accordingly (i.e., to produce (e.g., enact) pulse(s) as defined in the target pulse description).

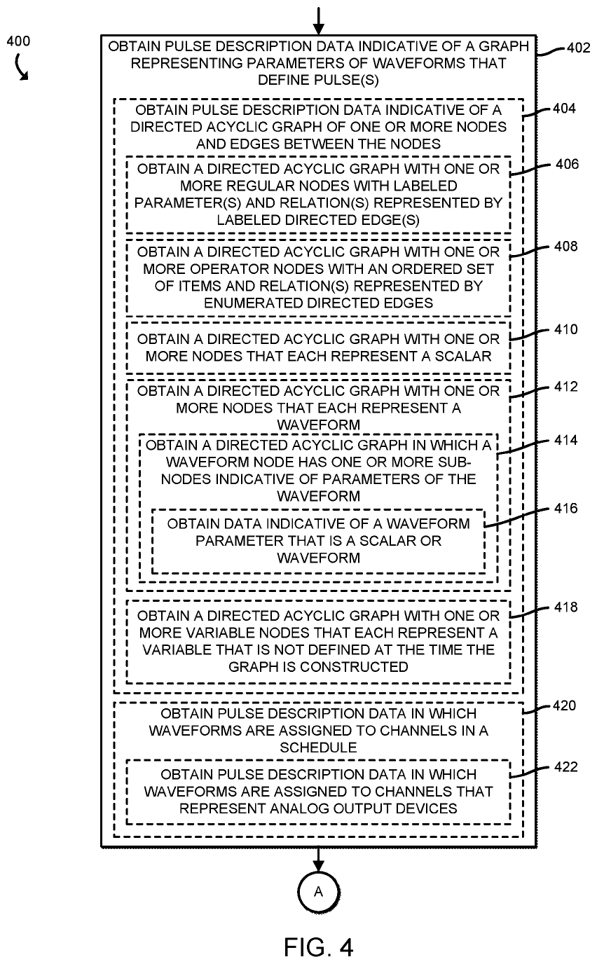

Referring now to FIG. 4, the system 100, and in particular, the graph management compute device 110, may execute a method 400 for providing a graph-based pulse-level programming framework for use in a target application (e.g., the target application 120). The method 400 begins with block 402, in which the graph management compute device 110 obtains (e.g., based on corresponding API calls) pulse description data. In the illustrative embodiment, the pulse description data is structured as a graph that represents parameters of one or more waveforms that define one or more pulses (e.g., finite duration pulse(s)). The graph management compute device 110 may read a data structure (e.g., in a file, in a stream, etc.) that defines the graph(s) or may iteratively build the graph in response to a series of API calls (e.g., from a program that is statically linked to, dynamically linked to, or otherwise connected to or in communication with the API 112). In doing so, the graph management compute device 110 may obtain pulse description data indicative of a directed acyclic graph of one or more nodes and edges between the nodes, as indicated in block 404. The graph management compute device 110 may obtain a directed acyclic graph with one or more “regular nodes”, which are nodes that have one or more labeled parameters and that have one or more relations, each represented by a corresponding labeled directed edge, as indicated in block 406. Additionally or alternatively, the graph management compute device 110 may obtain a directed acyclic graph with one or more “operator nodes”, each of which is a node with an ordered set of items (e.g., sub-nodes) and one or more relations represented by corresponding enumerated directed edges. That is the graph may include regular nodes and/or operator nodes.

In obtaining pulse description data indicative of an acyclic directed graph, the graph management compute device 110 may obtain a directed acyclic graph with one or more nodes that represent a corresponding scalar (e.g., a numeric value), as indicated in block 410. Further, in the illustrative embodiment, the graph management compute device 110 obtains a directed acyclic graph with one or more nodes that each represents a corresponding waveform, as indicated in block 412. That is, in the illustrative embodiment, the directed acyclic graph obtained (e.g., built, constructed, loaded to the memory 214, etc.) by the graph management compute device 110 includes scalar nodes and waveform nodes. In the illustrative embodiment, the graph management compute device 110 obtains a directed acyclic graph in which a waveform node has one or more sub-nodes that are indicative of parameters (e.g., frequency, phase, etc.) of the waveform, as indicated in block 414. The graph management compute device 110 may obtain data indicative of a waveform parameter that is structured as a scalar or as a waveform itself, as indicated in block 416. In the illustrative embodiment, the graph management compute device 110 may obtain a directed acyclic graph with one or more “variable nodes”, which are nodes that represent a corresponding variable that is not defined at the time the graph is constructed, as indicated in block 418. The graph management compute device 110 may obtain pulse description data in which waveforms are assigned to channels in a schedule, as indicated in block 420. The channels may represent analog output devices, as indicated in block 422.

Elaborating on the above, in the illustrative embodiment, the target independent architecture for a pulse representation is based on a set of basic waveforms with one or more parameters. As alluded to above, waveforms and parameters can be represented by nodes and relations between them as labeled directed edges, which results in a DAG. In the illustrative embodiment, the architecture focuses on the representation of finite duration pulses where a pulse's duration and parameters are known (e.g., defined) at compile time (e.g., before the kernel starts execution), but not necessarily at the time when the pulse representation is created (e.g., in a graph, such as a directed acyclic graph). Arbitrary pulse shapes are supported, but the full potential of the architecture becomes evident when used with parameterized basic waveforms.

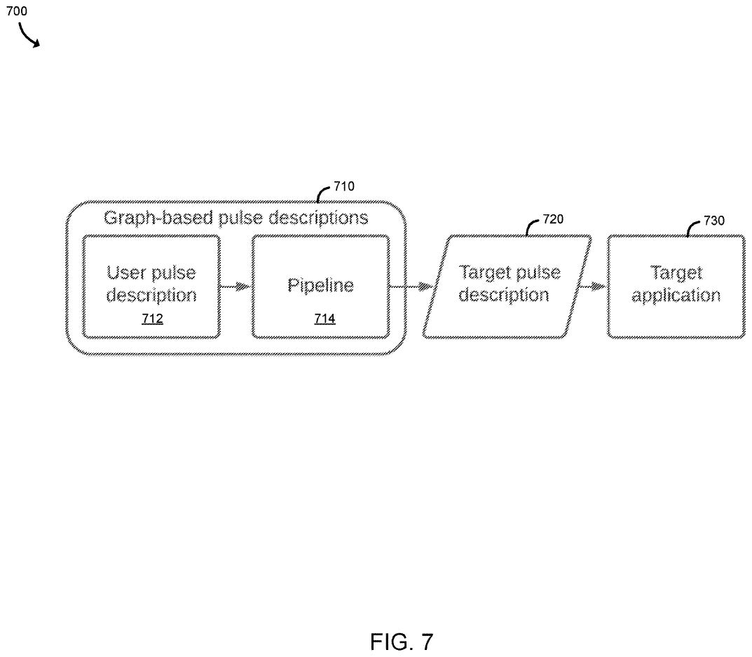

Referring briefly to FIG. 7, a workflow 700 associated with the architecture starts with one or more graph-based pulse descriptions 710. The graph-based pulse description(s) may be converted (e.g., by the graph management compute device 110) from one or more user-defined pulse descriptions 712, using a pipeline 714, to one or more target pulse descriptions 720. That is, once pulses are expressed using DAGs, the graph management compute device 110 may utilize one or more graph algorithms to validate and/or transform the pulses and apply techniques (e.g., compiler-related techniques) and intermediate representations (IRs). As described in more detail herein, the graph management compute device 110 may provide the resulting target pulse description(s) 720 to a target application 730 (e.g., the target application 120) as an input. In the following description, references to the architecture and/or operations performed by the architecture or objects provided by the architecture refer to operations performed by the graph management compute device 110, which implements the architecture and objects within it, based on the API 112.

As mentioned above, scalars may be embodied as nodes that represent a single value (e.g., without a time component). The most basic scalar, in the illustrative embodiment, is a number (Num), which represents an integer or float value. A number has no unit by itself and the unit it represents depends on the relation to its super-node (i.e., parent node). A number node, in the illustrative embodiment, can have multiple super-nodes and is by definition a leaf node. In at least some embodiments of the architecture, a variable scalar (Var) is available to represent numbers of which the value will be substituted later. A variable node can be used for pulse parameterization of the insertion of calibration parameters. Each variable scalar, in the illustrative embodiment, has a key that is used for substitution. To substitute a variable, the architecture (e.g., as implemented with the graph management compute device 110) maintains a key-value mapping to the node, and the value of the node is substituted using the key and the mapping.

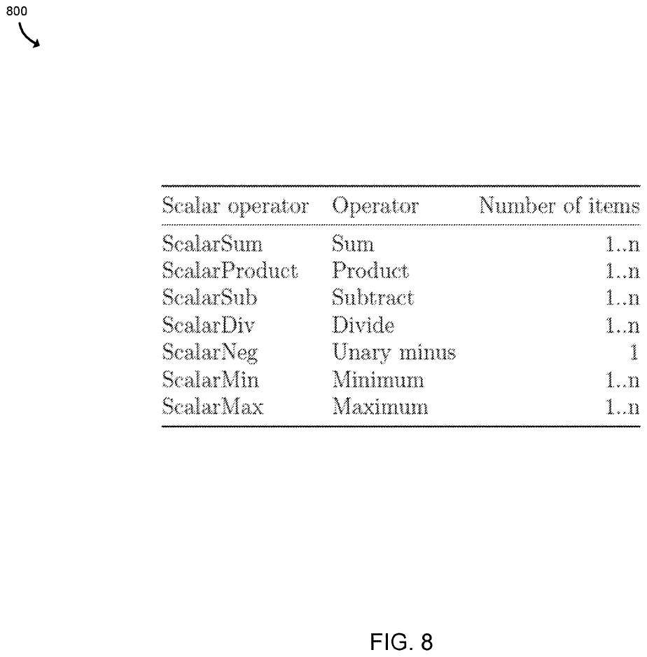

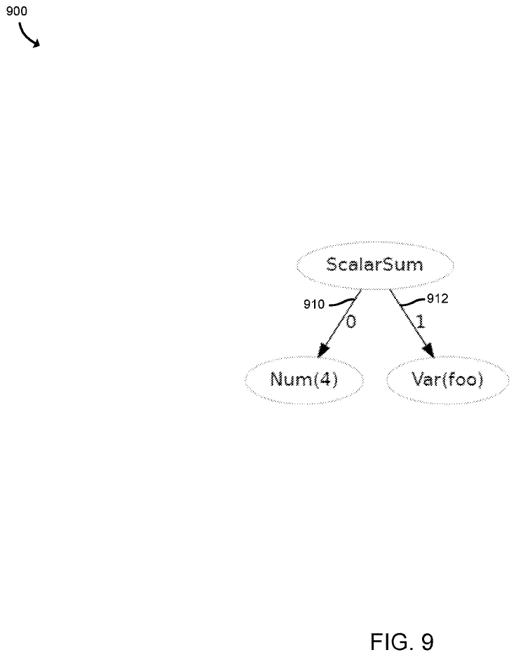

A user may wish to perform basic math operations on scalars. However, the presence of variables does not allow evaluation of the value of such operations until all variables involved are substituted. To allow math operations on scalars without evaluating the actual values, the architecture (e.g., the graph management compute device 110) utilizes operator nodes. A scalar operator node, in the illustrative embodiment, represents a math operation on a set of scalar nodes referred to as items. In the DAG representation, items are considered sub-nodes of the operator node. Scalar operators may include the sum, product, subtract, divide, unary minus, min, and max. In the illustrative embodiment, the unary minus operator only supports one item while the other scalar operators support one or more items. A list 800 of scalar operators and their properties is illustrated in FIG. 8. Further, an example embodiment of a directed acyclic graph 900 with a sum of a number and a variable is illustrated in FIG. 9. In the directed acyclic graph 900, the labels at the edges 910, 912 indicate the order of the operands. As such, with scalar operator nodes in a directed acyclic graph, basic math on numbers and variables may be expressed without the need to evaluate the actual values.

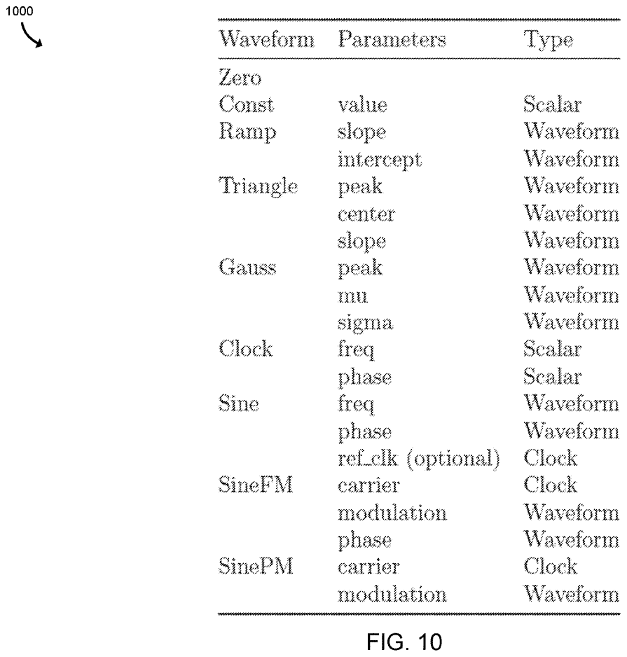

Regarding waveforms, in the illustrative embodiment, waveforms are embodied as nodes that represent a time-dependent value. Hence, waveforms always have a duration in the illustrative embodiment. Each waveform is defined in the domain [tₛₜₐᵣₜ, tₛₜₐᵣₜ+d) where tₛₜₐᵣₜ represents the start time of the waveform and d is the scalar duration of the waveform. Outside of its domain, a waveform has a value of 0.0. In the illustrative embodiment, waveforms are allowed to have infinite duration. Different waveform types may be represented by different nodes, where each has its parameters in addition to a duration parameter. Such parameters can be scalars or other waveforms to allow parameter modulation. In a DAG, parameter relations may be represented by directed and labeled edges between the waveform and the parameter node. A waveform with waveform parameters p₀, . . . , pₙ₋₁ will have a duration of min (d_{waveform}, dₚ₀, . . . , dₚₙ₋₁) where d_{waveform} is the configured duration of the waveform and dₚ₀, . . . , dₚₙ₋₁ are the durations of the waveform parameters. Hence, the waveform is only defined within a domain where all of its parameters are defined. A table 1000 of waveforms with parameters is shown in FIG. 10. In the illustrative embodiment, arbitrary waveforms can be represented by creating new waveform types.

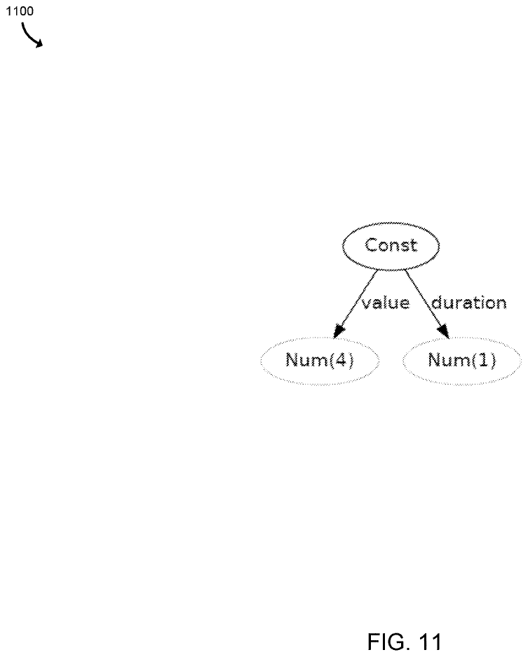

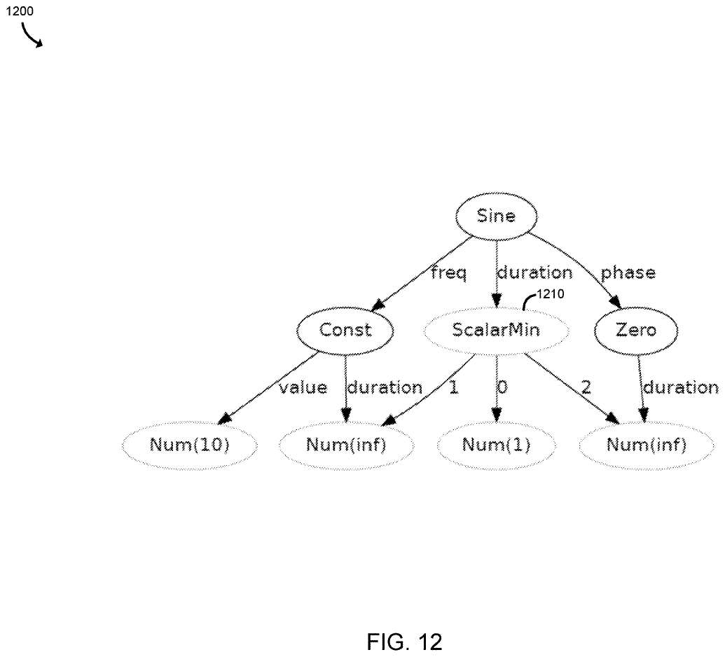

The simplest waveform type is zero, which represents a constant value of zero for a given duration. Besides the duration, the zero waveform has no parameters in the illustrative embodiment. The constant waveform, which represents a constant value within its domain, is configured by a scalar value parameter. An illustrative embodiment of a directed acyclic graph 1100 of a constant waveform is shown in FIG. 11. Other waveforms, such as the sine waveform, have waveform parameters that can change their value over time. Static parameters may be represented by constant waveforms. FIG. 12 illustrates a directed acyclic graph 1200 of a sine waveform with a fixed frequency and phase over time. Notably, the directed acyclic graph 1200 indicates that the sine duration is defined by the minimum of its parameters' durations and the configured duration of the sine waveform using the scalar operators (e.g., the operator node 1210).

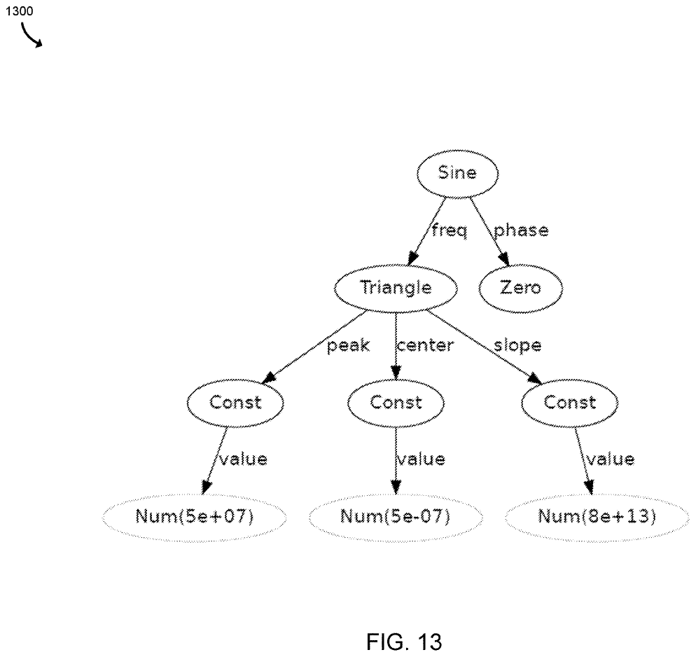

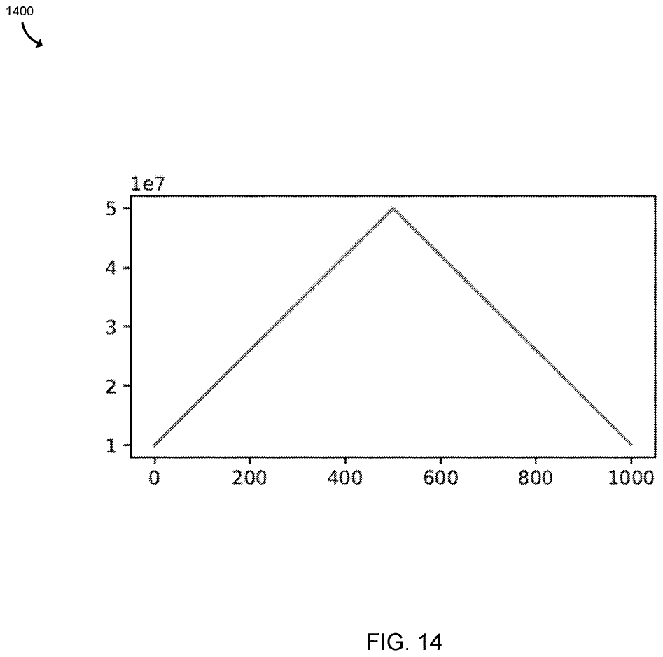

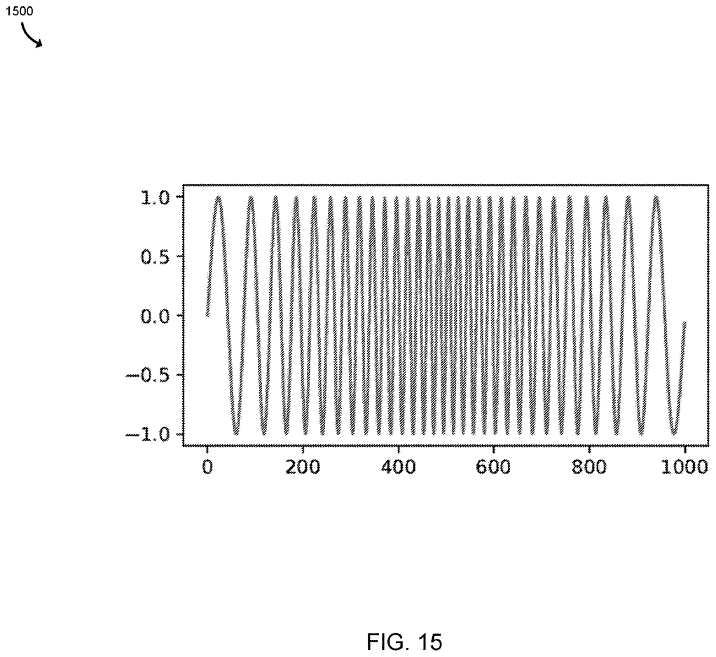

Waveform parameters can be modulated by using other waveforms as parameters. For example, a directed acyclic graph 1300 for a sine waveform with a triangle-modulated frequency is shown in FIG. 13. In the directed acyclic graph 1300 and in many other directed acyclic graphs illustrated in the figures, the duration nodes are omitted to increase readability. The frequency of the sine waveform in the DAG 1300 starts at 10 kHz and ramps up linearly to 50 kHz before ramping back to 10 kHz. Plots 1400, 1500 of the values of the triangle and sine waveforms are provided in FIGS. 14 and 15 respectively. Both plots 1400, 1500 have a duration of one microsecond using a sample rate of 1 GHz. The frequency-modulated sine wave in the plot 1500 is computed using a phase accumulator to prevent discontinuities.

Similar to scalars, the architecture, in the illustrative embodiment, enables operations (e.g., time-wise operations) on waveforms. In particular, the architecture utilizes waveform operators, similar to the operator nodes for scalars, but instead applied to waveforms. In the illustrative embodiment, waveform operators include sum, product, subtract, divide, and unary minus. The unary minus operator, in the illustrative embodiment, supports only one item while the other waveform operators support one or more items, similar to the scalar operators. The duration of waveform operators depends on the items contained in the operator. In the illustrative embodiment, as discussed above, the value of a waveform outside of its domain is 0.0. A product or division containing zero is nonsensical. Accordingly, the duration of these operators in the illustrative embodiment is the minimum duration of their items. For the sum and subtract operators, the duration of the waveform operator, in the illustrative embodiment, is the maximum duration of its items. In other embodiments, the duration may be the minimum duration of the items.

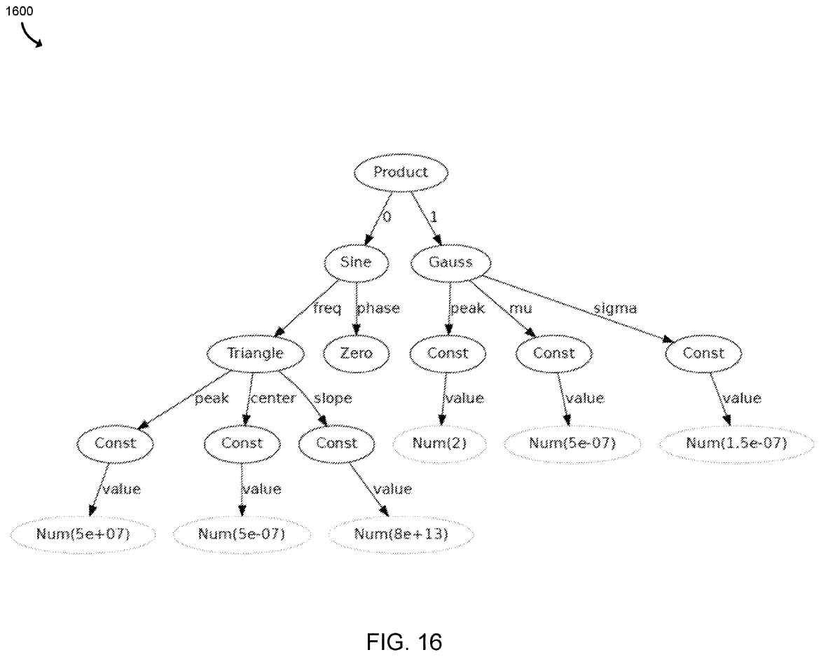

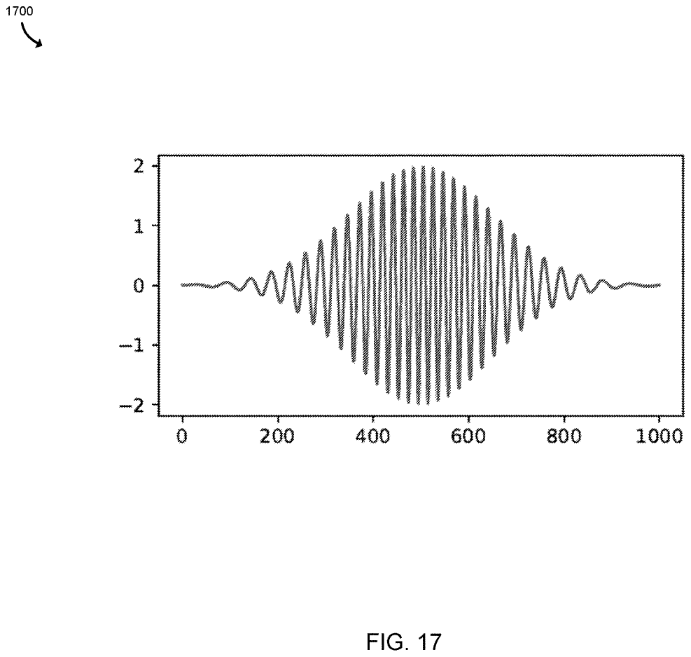

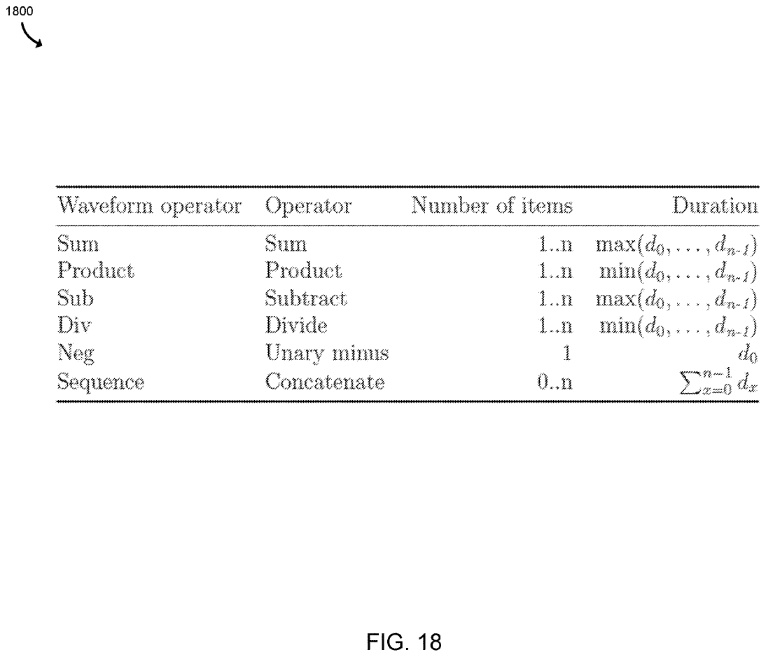

The product operator may be used to create a sine wave with amplitude modulation. FIG. 16 represents a directed acyclic graph 1600 similar to the directed acyclic graph 1300 of FIG. 13, but with added Gaussian amplitude modulation using the product operator. The resulting waveform is shown in the plot 1700 of FIG. 17 using the same duration (e.g., one microsecond) and sample rate (e.g., 1 GHZ) used in the plot 1500 of FIG. 15. Another waveform operator available in the illustrative embodiment of the architecture is the sequence operator, which may be used to concatenate waveforms. The sequence operator has zero or more items and, in the illustrative embodiment, its duration is the sum of the duration of all of its items. The sequence operator can be used to sequentially order waveforms and has applications ranging from building longer waveforms to creating complex modulation patterns. An important side-effect of the sequence operator is the shifted starting time of waveforms. That is, waveforms with a phase could be affected by a shifted starting time while other waveforms are insensitive to shifts in starting time. FIG. 18 provides a list 1800 of waveform operators and their properties. In the list, dx represents the duration of item x.

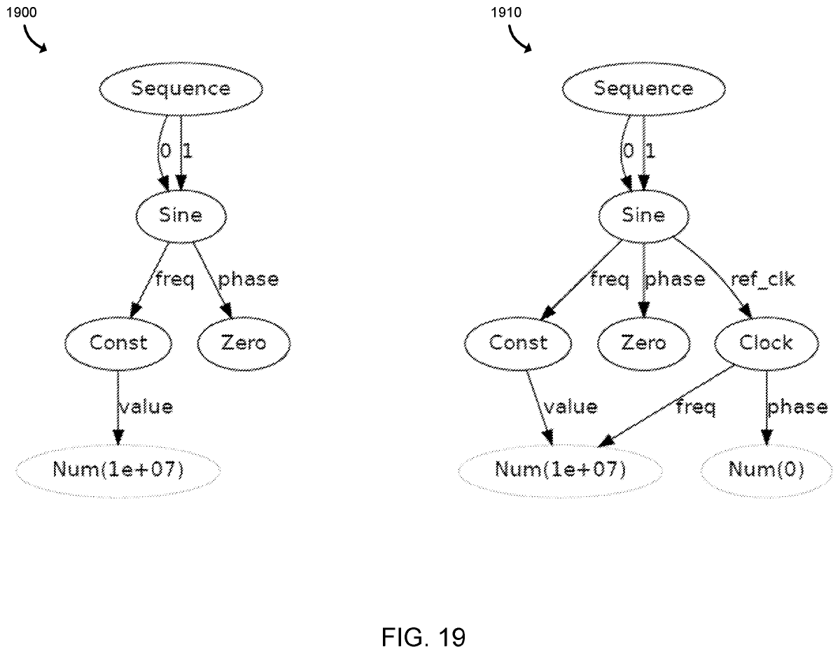

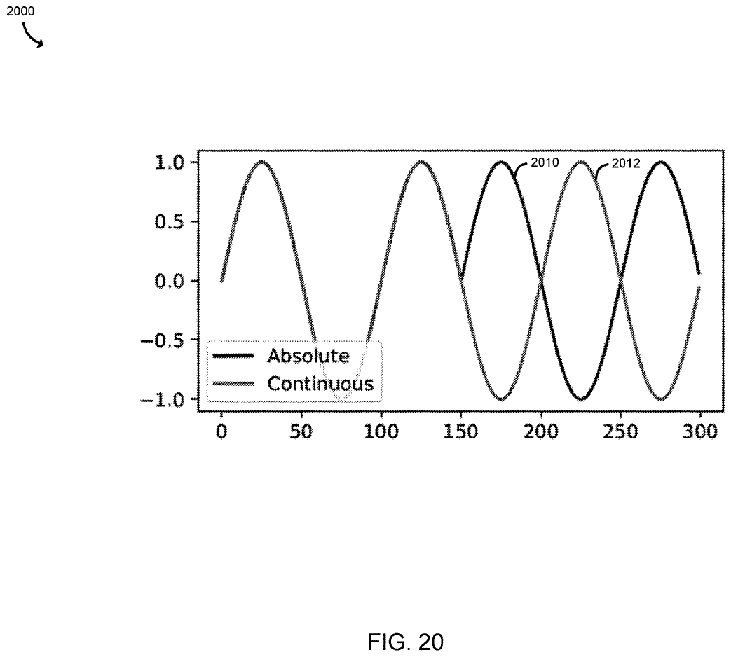

The architecture, in some embodiments, may support multiple phase modes for waveforms with a phase. Those phase modes may include absolute and continuous. Phase mode absolute, in the illustrative embodiment, indicates that the phase of a waveform (e.g., in radians) is insensitive to the waveform's start time and only depends on the phase parameter of the waveform. Alternatively, phase mode continuous, in the illustrative embodiment, indicates that the phase of a waveform is time-dependent. The initial phase offset, in the illustrative embodiment, is derived from a reference clock and the phase parameters of the waveform is relative to the initial phase offset. The reference clock, in the illustrative embodiment, is a clock waveform with a scalar frequency and phase from which the initial phase offset can be calculated at any start time. The usage of a reference clock allows the architecture to support a wide range of phase synchronization methods, including situations where phase tracking is performed at a different frequency than the waveform itself. FIG. 19 shows graphs 1900, 1910 of two identical sine waves with absolute (e.g., in the graph 1900) and continuous (e.g., in the graph 1910) phase modes. A plot 2000 of both waveforms 2010 (e.g., corresponding to absolute phase mode), 2012 (e.g., corresponding to continuous phase mode) is shown in FIG. 20. The plot 2000 represents a duration of 0.3 microseconds and a sample rate of 1 GHZ. In the left half of the plot 2000, both waveforms 2010, 2012 overlap. In the right half of the plot 2000, a clear difference between the absolute and continuous phase modes is present.

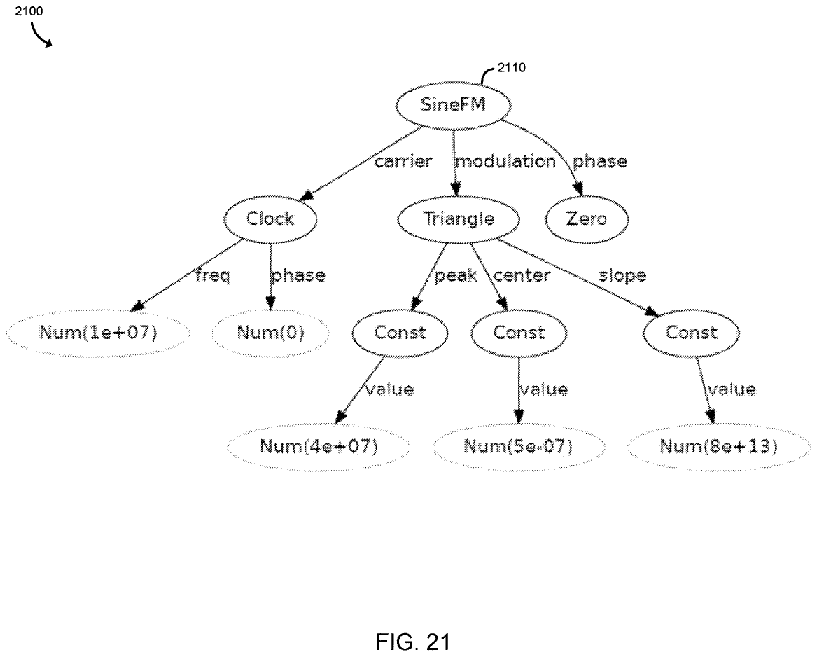

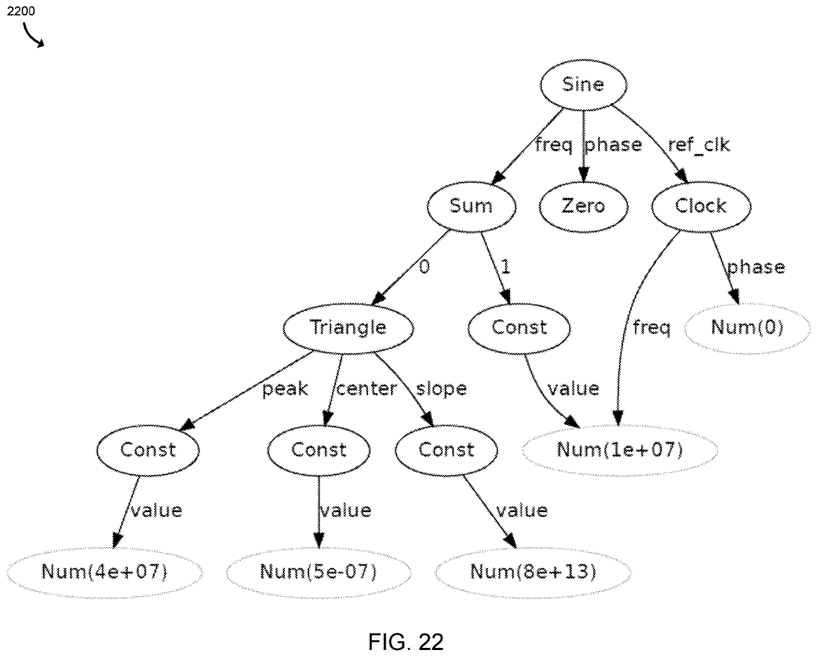

Frequency and phase-modulated since waveforms often use a carrier waveform and a modulation pattern that is relative to the carrier. In the illustrative embodiment, the architecture includes special waveform types for frequency and phase-modulated sine waveforms based on a carrier waveform. Those special waveform types are the sine FM and sine PM waveforms, respectively. Both waveforms, in the illustrative embodiment, have a carrier and modulation parameter, where the carrier is a clock waveform and the modulation is relative to the carrier waveform. In the illustrative embodiment, for modulated sine waveforms, the carrier is the reference clock. FIG. 21 shows a graph 2100 of a sine FM waveform based on a 10 MHz carrier, which will generate the waveform in the plot 1500 of FIG. 15. The sine FM waveform can be expanded to an equivalent regular sine waveform. A graph 2200 of the equivalent regular sine waveform is shown in FIG. 22. The graphs 2100, 2200 clearly show how the sine FM node 2110 of FIG. 21 can compactly store carrier information, making the graph 2100 easier to interpret than the graph 2200.

Waveforms enable the efficient description of individual pulses and sequentially timed pulses using the sequence waveform operator and zero waveforms. In the illustrative embodiment, the architecture also supports channels and a schedule to allow descriptions of multi-channel pulse schemes. A channel may be embodied as a unique identifier that represent an abstract analog output device. While a channel has a label for representation purposes, the labels need not be unique. In the illustrative embodiment, a user may create any number of channels and provide semantics for each created channel. As mentioned above, the channels may represent physical analog output devices, for example, and a set of channels can be interpreted as an abstract device model. For example a trapped-ion quantum computer (e.g., such as in the system 300) may have a channel for a global beam and one individual beam channel for each ion.

A schedule, in the illustrative embodiment, is a map from channels to waveforms. All waveforms in a schedule, in the illustrative embodiment, have the same duration and are executed in parallel on their respective channels. The schedule object provides utilities to construct valid multi-channel waveforms by providing a sequential and parallel context that can be nested in any arbitrary way. When a schedule is constructed, the parameters of waveforms, including the duration, may still be variable. Hence, in those situations, it is not possible to evaluate the exact start and end time of waveforms. Using sequential and parallel semantics in combination with scalar operators allows users to construct practical schedules in the presence of variable waveform durations. In the illustrative embodiment, once all variable in a schedule are resolved (e.g., their actual values are defined), all waveform start and end times are determined (e.g., by the graph management compute device 110), and the schedule preserves its sequential and parallel semantics.

In the illustrative embodiment, the architecture enables users to add waveforms to specific channels using the schedule object. By default, the schedule may start in a sequential context which is stored on the schedules' timing context stack. A user may enter and exit new contexts, which will be added and removed from the stack. Depending on the current context (i.e., the context on top of the stack), a waveform will be added to the schedule with sequential or parallel semantics. In the illustrative embodiment, in a sequential context, the provided waveform is appended to the current waveform of the given channel, and a zero waveform of the same scalar duration is appended to all other channels in the schedule. In a parallel context, in the illustrative embodiment, only one waveform can be added to each channel in the schedule. When another waveform is added to the same channel, the latest waveform will overwrite the existing one. The duration of a parallel context, in the illustrative embodiment, is defined as the maximum duration of its waveforms. When the parallel context is closed, a scalar max operator is used (e.g., by the graph management compute device 110) to obtain the duration of the context, and each waveform in the context is padded with a zero waveform to ensure that all waveform durations are equal. In the illustrative embodiment, when the user exits a timing context, that timing context is removed from the stack (e.g., by the graph management compute device 110) and its contents are added to the new context on top of the stack.

By default, in the illustrative embodiment, the duration of the sequential and parallel contexts scales dynamically based on the added waveforms. Dynamic scaling of context duration is convenient for situations where the duration between waveforms is expressed as the time between the end of one waveform and the start of another. The sequential and parallel context can optionally be configured with a target duration given as a scalar. The target duration allows users to express the start time of one waveform relative to the start time of another, which can be convenient for specific situations. When a context is configured with a target duration, in the illustrative embodiment, the context will add additional padding to each channel when the context is closed to meet the target context duration. Configuring a target duration for a context can lead to invalid schedules, for example, if a waveform added to the context has a longer duration than the target context duration. Scheduling violations might not be known when the schedule is created due to variable waveform durations. Once all variables are substituted, scheduling violations can be recognized by waveforms with a negative duration.

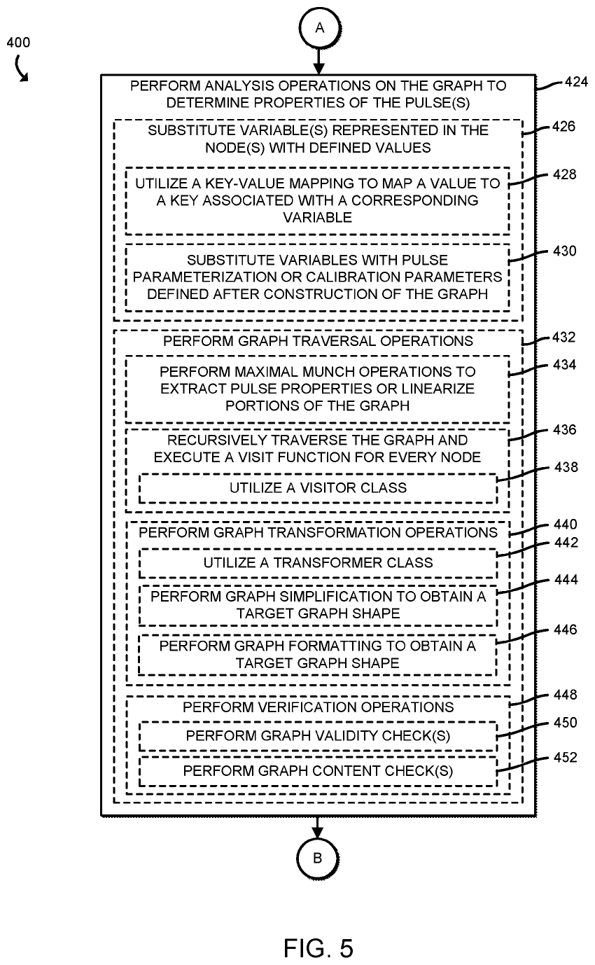

Referring now to FIG. 5, and continuing the method 400, the graph management compute device 110, performs one or more analysis operation on the graph (e.g., the acyclic directed graph) to determine properties of the pulse(s) represented by the graph, as indicated in block 424. In doing so, the graph management compute device 110 may substitute one or more variables represented in the nodes (e.g., in variable nodes) with corresponding defined values, as indicated in block 426. In performing the substitutions, the graph management compute device 110 may utilize a key-value mapping (e.g., in the memory 214 or the data storage 222) to map a value to a key associated with a corresponding variable, as indicated in block 428. That is, the graph management compute device 110 may look up a value in the map based on a key (e.g., used as an index) associated with a corresponding variable node, then replace the variable with the value. In making the substitutions, the graph management compute device 110 may substitute variables with pulse parameterization or calibration parameters that are defined after construction of the graph (e.g., the acyclic directed graph). That is, the graph may be entirely constructed before actual values for the variables are known (e.g., defined or redefined by a user), as indicated in block 430.

The graph management compute device 110, in the illustrative embodiment, performs graph traversal operations on the directed acyclic graph, as indicated in block 432. In doing so, the graph management compute device 110 may perform maximal munch operations to extract pulse properties (e.g., from the graph) or to linearize one or more portions of the graph, as indicated in block 434. In performing the graph traversal operations, the graph management compute device 110 may recursively traverse the graph (e.g., the acyclic directed graph) and execute a visit function for every node in the graph, as indicated in block 436. In the illustrative embodiment, the graph management compute device 110 does so using a visitor class, as indicated in block 438.

The graph management compute device 110 may perform graph transformation operations on the graph (e.g., the acyclic directed graph), as indicated in block 440. In performing graph transformation operations, the graph management compute device 110 may utilize a transformer class, as indicated in block 442. Further, in performing the graph transformation operations, the graph management compute device 110 may perform graph simplification operations and/or graph formatting operations, as indicated in blocks 444, 446 to obtain a target graph shape (e.g., a graph shape that is usable as an input to the target application 120, given that the target application 120 may have an expected format for input data and may be unable to parse the graph in its unmodified form). In performing the graph traversal operations, the graph management compute device 110 may perform one or more verification operations, as indicated in block 448. The verification operations may include one or more graph validity checks, as indicated in block 450 and/or one or more graph content checks, as indicated in block 452.

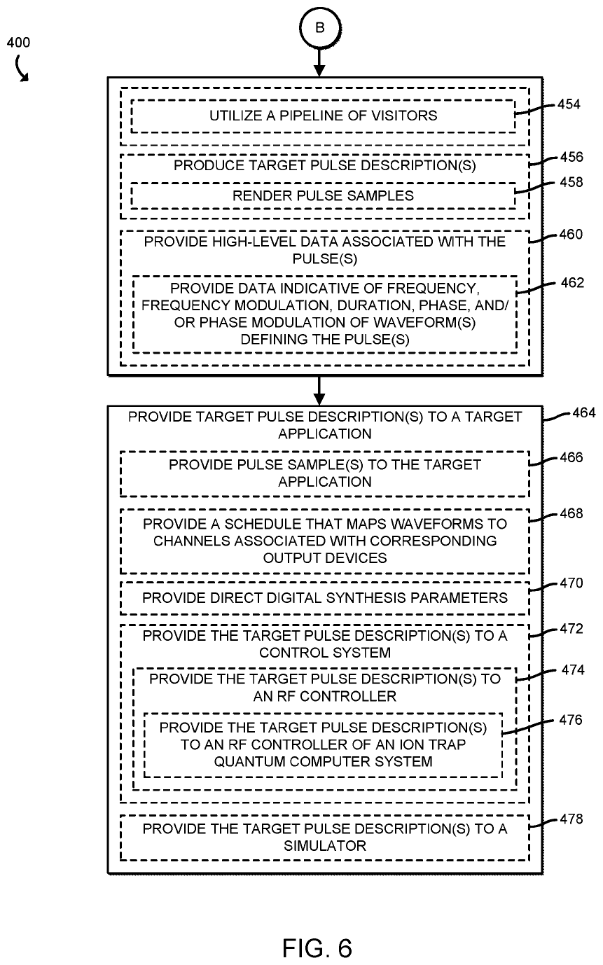

Referring now to FIG. 6, as indicated in block 454, the graph management compute device 110 may utilize a pipeline of visitors in performing the graph traversal operations. As indicated in block 456, in performing the analysis operations on the graph, the graph management compute device 110, in the illustrative embodiment, may produce one or more target pulse descriptions, which may be embodied as data in a format usable by the target application as an input (e.g., a re-shaped version of the acyclic directed graph based on the transformation operations from block 440, time series data, etc.). As indicated in block 458, in producing the target pulse description(s), the graph management compute device 110 may render one or more pulse samples (e.g., into time series data indicative of the pulse(s)). In at least some embodiments, as a result of the analysis operations, the graph management compute device 110 may provide (e.g., extract from the graph) high-level data associated with the pulse(s), as indicated in block 460. The graph management compute device 110 may, for example, provide the high level-data to the target application 120, display the data (e.g., to a user through a display device), and/or write the data to a file or other data structure. In providing the high-level data, the graph management compute device 110 may provide data indicative of the frequency, frequency modulation, duration, phase, and/or phase modulation of waveform(s) that define the pulse(s), as indicated in block 462.

Continuing the method 400, and as indicated in block 464, the graph management compute device 110 may provide the target pulse description(s) (e.g., from block 456) to the target application 120 (e.g., to produce the corresponding pulse(s) according to the target pulse description). In doing so, the graph management compute device 110 may provide one or more pulse samples (e.g., from block 458) to the target application 120, as indicated in block 466. Additionally or alternatively, the graph management compute device 110 may provide a schedule (e.g., a data structure) that maps waveforms to channels associated with corresponding output devices (e.g., analog output devices) of the target application 120, as indicated in block 468. The graph management compute device 110, in some embodiments, may provide direct digital synthesis parameters to the target application 120, as indicated in block 470. In the illustrative embodiment, the graph management compute device 110 provides the target pulse description(s) to a control system (e.g., the target application 120 is a control system in the illustrative embodiment), as indicated in block 472. For example, and as indicated in block 474, the graph management compute device 110 may provide the target pulse description(s) to an RF controller (e.g., the RF controller 318). In the illustrative embodiment, the graph management compute device 110 provides the target pulse description(s) to an RF controller of an ion trap quantum computer system (e.g., the RF controller 318 of the system 300), as indicated in block 476. In other embodiments, the graph management compute device may provide the target pulse description(s) to a simulator (e.g., a simulator of one or more components of a quantum computer system) or other target application, as indicated in block 478.

To elaborate more on the operations of FIGS. 5 and 6, a discussion of specific embodiments of the architecture and associated operations that may be performed by the graph management compute device 110 (e.g., through the use of corresponding objects, classes, and structures) is provided below. Using the directed acyclic graph (DAG) representation of complex pulse(s) enables the graph management compute device 110 to validate and transform pulse representations using recursive graph algorithms. A graph visitor and transformer architecture may be utilized to obtain a desired (e.g., target) pulse format, as described herein. In the illustrative embodiment, the graph algorithms used in the architecture (e.g., by the graph management compute device 110) are based on a visitor technique that recursively walks over the graph and calls a visit function for every node. Such a visitor technique may be that used in the Python abstract syntax tree (AST) module. In the illustrative embodiment, a visitor is a class with a visit( ) method that takes a node as an argument and returns a node. For each node that is visited, the visitor (e.g., the graph management compute device 110 implementing the operations of the visitor) tries to find an appropriate visit method based on the class (e.g., type) of the node. When found, the class-specific method is called (e.g., executed by the graph management compute device 110) with the node as the argument. If no visit method is found, a generic visit method is used (e.g., executed by the graph management compute device 110), which will call the visit( ) method on all sub-nodes of the current node. Parameters of a node and items of an operator node are considered sub-nodes in the DAG representation. Finally, in the illustrative embodiment, the visit( ) method returns the original node.

In the illustrative embodiment, the visitor infrastructure is extended with type matching based on the class or superclass of the node. The matching algorithm (e.g., executed by the graph management compute device 110) first searches for a visit method for the class of the current node. If no match is found, the visit( ) method (e.g., the graph management compute device 110 executing the visit( ) method) will continue the search for a class-specific visit method using the superclasses of the node. If none of the node superclasses returns a match, the generic visit method is called (e.g., executed by the graph management compute device 110). For languages that support multiple inheritance (e.g., Python), superclasses will be searched (e.g., by the graph management compute device 110) in the order determined by the C3 superclass linearization algorithm (e.g., the method resolution order (MRO) in Python). The architecture also allows class-specific visit methods to reject a node, which will cause a the visit( ) method to continue the search for a visit method. The visitor infrastructure, in the illustrative embodiment, implements a form of structural pattern matching that matches the class and superclass of the current node. More complex structural pattern matching, such as that used in maximal munch, can be achieved by overriding the default behavior of the visitor.

Visitors (e.g., executed by the graph management compute device 110) can traverse over the DAG of a pulse and extract properties or information. To modify and transform a DAG, the architecture (e.g., the graph management compute device 110), in the illustrative embodiment, utilizes a transformer class, which is an extension of the visitor class. A transformer works based on the same principles as the visitor, except that visit methods can return any node. The returned node can be the original node passed to the visit method to indicate that the node remains unchanged. If a different node is returned, the new node, in the illustrative embodiment, will replace the original node. The generic visit method of the transformer calls the visit( ) method on all sub-nodes of the current node and if any changes to the sub-node are detected (e.g., by the graph management compute device 110), the current node is reconstructed (e.g., by the graph management compute device 110) with the new sub-nodes.

Visitors and transformers can be used to verify and transform user-provided pulse descriptions into representations that suit the need of the target application 120. The transformations may include graph simplification and graph formatting, to ensure that the graph has a predetermined shape (e.g., in the shape or format usable as an input to the target application 120). Verification algorithms include graph validity checks and graph content checks. Such algorithms can be used to ensure the target application 120 supports a given pulse description. Visitors and transformations, in the illustrative embodiment, map graphs to graphs, and are normally stateless (e.g., functional). Further, visitors with linearization algorithms (e.g., maximal munch) can convert graph-based pulse descriptions to linear data formats for consumption (e.g., as an input) by the target application 120. Visitors that convert graph-based pulse descriptions to other formats can use local data structures to generate output as a side-effect while traversing the graph. Hence, these visitors are not stateless and, in the illustrative embodiment, their internal state is cleared before they are reused for a second pass.

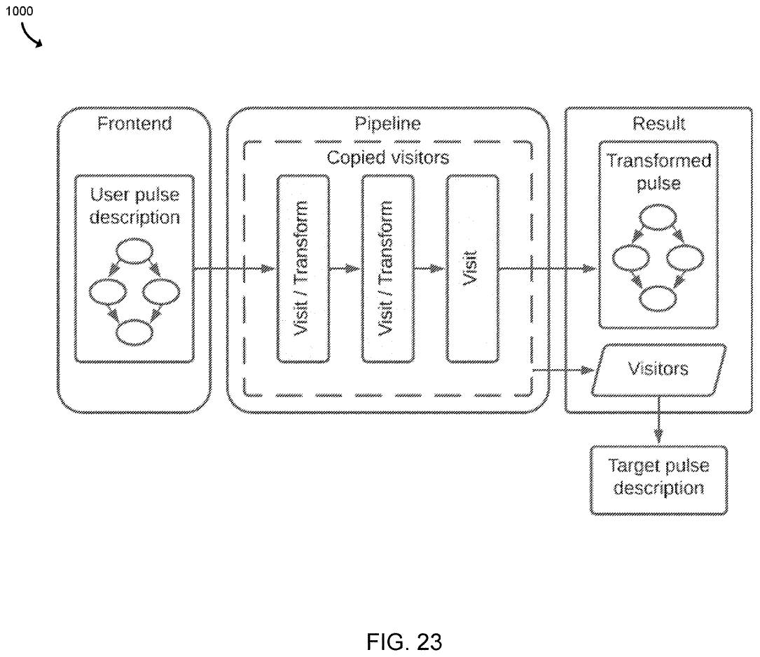

A common use case for visitors and transformers may be to take a user pulse description or schedule as an input and use a sequence of visitors to transform the graph-based pulse descriptions to a desired target format. In the illustrative embodiment, the architecture includes a pipeline to collect a sequence of visitors and apply them all sequentially on a pulse or schedule. A pipeline, in the illustrative embodiment, contains a sequence of visitors (and transformers) and has a run( ) method that accepts a single graph or a schedule. In response to execution of the run( ) method with a graph as the argument, the pipeline (e.g., the graph management compute device 110 implementing the pipeline) makes a copy of all visitors and applies them to the graph sequentially, where the output of the previous visitor becomes the input of the next visitor. After the last visitor is applied, the pipeline (e.g., the graph management compute device 110 implementing the pipeline) constructs a result object, which may be embodied as a tuple of the final graph and the visitors used to obtain the result. In response to the run( ) method being called with a schedule as the argument, the pipeline (e.g., the graph management compute device 110 implementing the pipeline) returns a map with channels and result objects as keys and values respectively. In the illustrative embodiment, the sub-pipeline for each channel is independent. As such, the graph management compute device 110 may execute their operations in parallel using multiprocessing techniques. In the illustrative embodiment, the pipeline works in a method similar to a compiler, where the graph functions as an intermediate representation (IR). A schematic 2300 that includes an embodiment of a pipeline operating on a single graph (e.g., a user defined pulse description) is provided in FIG. 23.

In the illustrative embodiment, the pipeline (e.g., the graph management compute device 110 implementing the pipeline) may perform deep copies. Most visitors are stateless, which means the same object can be reused for multiple graphs or channels, but there may be exceptions. As mentioned above, visitors with linearization algorithms can be stateful and, as such, certain visitors would need their internal state to be cleared (e.g., reset) before being reused. However, in at least some embodiments, rather than clearing the state of stateful visitors, the architecture (e.g., the graph management compute device 110) creates a copy of each visitor before it is applied to a graph. In those embodiments (e.g., that copy each visitor), the state of the visitors after traversing the graph becomes part of the result. Hence, the visitors in those embodiments are part of the result object constructed for each graph that is processed by the pipeline.

The following is a description of a specific implementation (e.g., embodiment) of the architecture and operations discussed above. From a graph perspective, there are only two fundamental node types: regular nodes and operator nodes. Regular nodes have labeled parameters nodes and their relations are represented by labeled directed edges. Operator nodes have an ordered set of items where the relations are represented in the graph by enumerated directed edges. At the same time, a node can either be a scalar or a waveform. With Python as the host language, the architecture implementation uses a class structure based on multiple inheritance. For multiple inheritance, Python uses the C3 superclass linearization algorithm to derive the MRO of a class. The implementation of the architecture uses mixins to ensure that the inheritance structure leads to a valid MRO.

In the implementation, the class structure starts at the root with an abstract BaseNode class, which is the superclass of the (regular) Node and the OperatorNode class. The BaseNode class defines an abstract method to iterate over sub-nodes, which can be used to easily walk over the graph independent of the node class. A Node stores its labeled parameters in a dictionary where the keys are the strings of the labels and the values are node objects. An OperatorNode stores its items in a list of node objects. To distinguish between scalar and waveform nodes, the implementation utilizes two abstract mixin classes, Scalar and Waveform, which both inherit from the BaseNode class. The mixin classes define generic abstract methods for their respective type, which is a value( ) method for the Scalar class and a duration( ) method for the Waveform class.

A concrete scalar node class is created by inheriting the Scalar and the Node class. For example, the number scalar class is defined as Num(Scalar, Node). The inheritance order is relevant for resolving the MRO, and the mixin should be the leftmost class in the inheritance order to get the desired MRO. The number scalar takes a float as an argument which is the value the node represents. The variable scalar, defined as Variable(Scalar, Node), takes a key as an argument and has methods for substitution and clearing. The substitute( ) method takes a dictionary that maps keys to values. The variable will look up its key in the dictionary and store the corresponding value. The clear( ) method clears the memory that stores the value of the variable. Concrete waveform node classes use an inheritance structure similar to scalars. Hence, the constant waveform class is, for example, defined as Const(Waveform, Node). All waveforms listed in the table 1000 of FIG. 10 are implemented using the same inheritance structure.

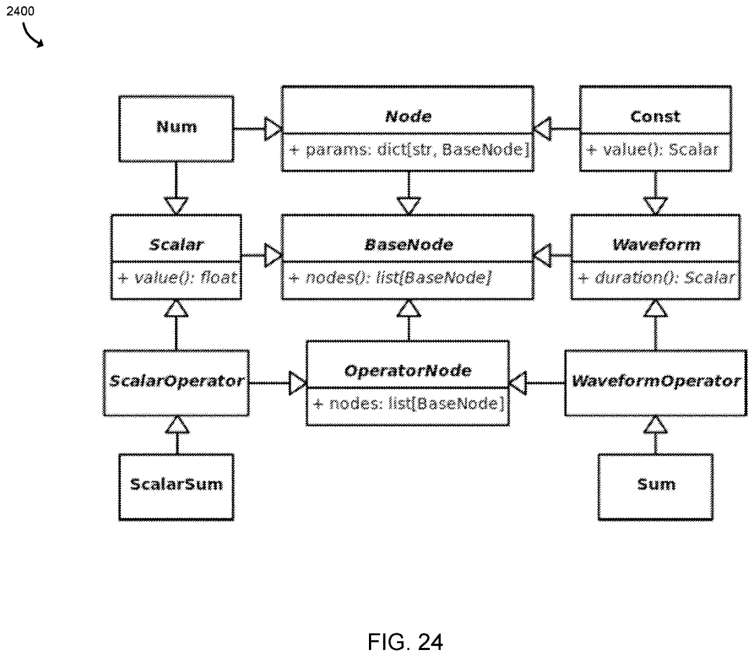

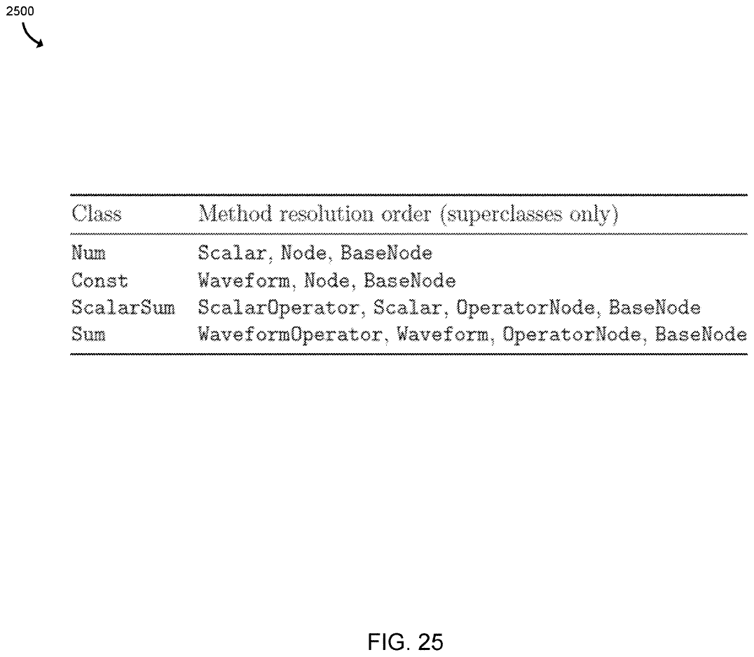

For operators, the implementation utilizes two intermediate abstract classes: ScalarOperator and WaveformOperator. Both classes inherit from their respective mixin class and the OperatorNode class. The intermediate operator classes do not add any functionality to their subclasses but allow visitors to create specific visit methods for scalar and waveform operators based on the type-matching algorithm. Scalar and waveform operators can be created by inheriting their respective operator class, for example, ScalarSum(ScalarOperator) and Sum(WaveformOperator). The partial class diagram 2400 for nodes, scalars, and waveforms is shown in FIG. 24 which includes the concrete classes for Num, Const, ScalarSum, and Sum. The method resolution order (MRO) for the same four concrete classes is shown in the table 2500 of FIG. 25.

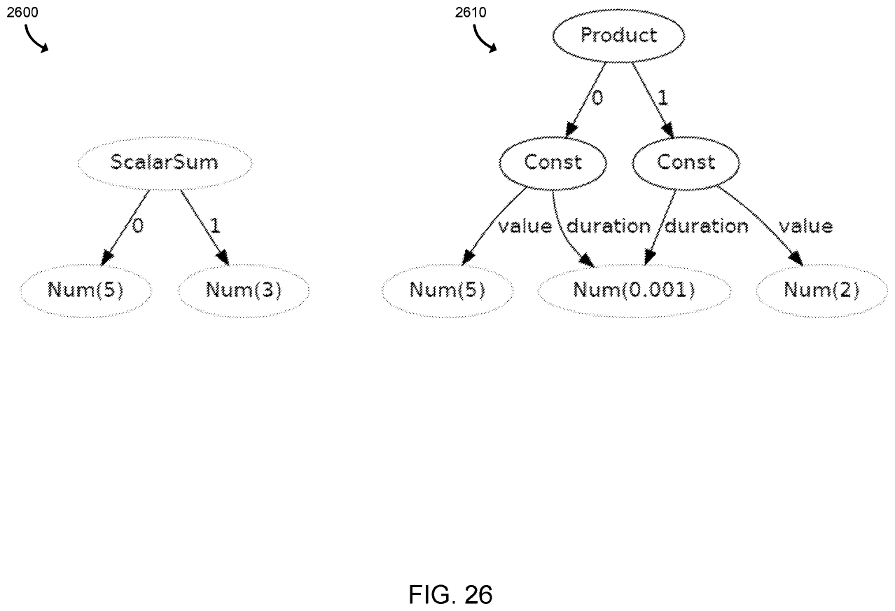

The BaseNode class and all of its subclasses are immutable, similar to graph objects in functional languages. Immutable nodes allow graph algorithms to recognize modifications in sub-nodes or subgraphs by comparing object identities and guarantee that sub-nodes cannot be mutated after a node is constructed. Any change in a leaf node will cause all of its super-nodes to be reconstructed, while subgraphs can be reused by multiple super-nodes. Additionally, the implementation utilizes Python__slots__to prevent users from dynamically adding attributes to any node in the graph. The Scalar and Waveform classes also overload a set of operators to allow users to create operator nodes using their respective operator syntax (i.e., a+b for a scalar or waveform sum). Since nodes are immutable, in-place operators return new operator nodes as well. Implicit type casting allows objects of type int or float to be promoted to Num scalars while all Scalar types can in turn be promoted to Const waveforms. When a type is implicitly promoted to a Const waveform using an operator, the duration of the new waveform is set to the duration of the left operand. FIG. 26 shows the resulting graphs 2600, 2610 of using an operator on a scalar or waveform with implicit type promotion on the right operand.

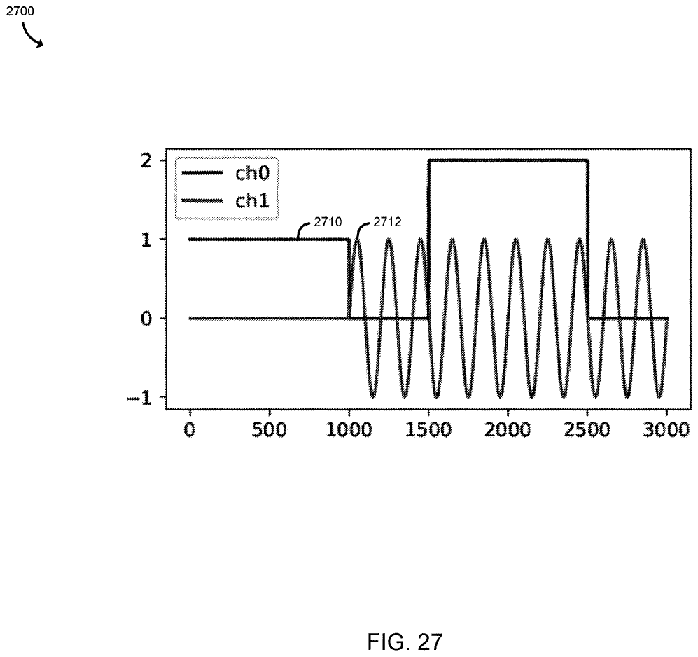

The implementation includes a Channel class and a Schedule class to create pulse schedules. The Channel class only functions as an identifier to distinguish channels and additionally stores a non-unique label to provide a name for the channel. Besides the label, the channel object has no additional functionality. The Schedule class is a context and has an add( ) method that takes a channel and a waveform as arguments. When entering the schedule context, a time-context stack with a single sequential time context is created. The time context on top of the stack is considered the current context. Users can request new sequential and parallel time contexts from the schedule object. The duration of a time context scales dynamically by default, but users can pass a fixed context duration if desired. A time context is pushed to the stack when entered and removed when exited. The add( ) method of the schedule object forwards the call to the current time context, which will decide its timing interpretation and store the information in a dictionary with channels and waveforms as keys and values, respectively. When a time context is removed from the stack, its contents are extracted and added to the time context now at the top of the stack. Interpretation and details of the sequential and parallel time context are outlined herein. In the implementation, a schedule never tries to resolve the duration of a waveform at any time and instead uses scalar operators to determine the durations of padding waveforms. Once all durations are known, a transformation can easily remove any redundant padding nodes. When the user exits the schedule context, the initial sequential context is closed, and its waveform dictionary, which represents the full schedule, is extracted. The schedule stores the dictionary, and users can request the waveform dictionary from the schedule object. The following code snippet in Table 1 creates a simple two-channel schedule, and the plot 2700 in FIG. 27 shows the resulting waveforms 2710, 2712 representing ch0 and ch1 respectively.

TABLE 1
Snippet of a two-channel schedule with
sequential and parallel waveforms.

```
ch0, ch1 = Channel(‘ch0’), Channel(‘ch1’)
with Schedule( ) as s:
  s.add(ch0, Const(value=1, duration=1e−6))
  with s.parallel( ):
    with s.sequential( ):
      s.add(ch0, Zero(duration=0.5e−6))
      s.add(ch0, Const(value=2, duration=1e−6))
      s.add(ch1, Sine(freq=5e6, duration=2e−6))
```

For visualization purposes, the implementation utilizes a recursive algorithm that creates a Graph Viz file from a pulse description. The implementation uses the Python Graph Viz library to create a *.gv file which can be rendered using the Graph Viz dot program for DAGs. In the implementation, all waveform classes implement a to_array( ) method that recursively calculates the samples of a waveform given a sample rate. The to_array( ) method can be used to target an AWG device, export waveforms to a standard value change dump (VCD) file using PyVCD, or plot waveforms using a tool like Matplotlib.

The implementation includes base classes for visitors and transformers that implementations of graph algorithms can inherit. The abstract BaseVisitor class contains an abstract visit( ) method that takes a BaseNode as an argument and returns a BaseNode. The concrete Visitor and Transformer classes inherit from the Base Visitor class. The visit( ) method of the Visitor class implements a type-matching algorithm that obtains the MRO from the node's class and iterates over the classes to find a matching visit method. The class-specific visit method is found by dynamically searching for a method visit_*( ) where the asterisk represents the (case sensitive) name of the target class. If a class-specific visitor method is found, the method is called with the current node as an argument. The class-specific visit method can raise a Continue Visit exception, in which case the search for a class-specific visit method continues. If no appropriate visit method was found, the current node is passed to the generic_visit( ) method. The generic visit method continues the graph traversal by calling the visit( ) method on all sub-nodes. By default, the Visitor class visits all nodes depth-first. Finally, the visit( ) method returns the original node that was passed as an argument. The implementation of the Visitor class, including the MRO traversal and the Continue Visit handling, is shown in Table 2. More complex structural pattern matching can be achieved by implementing a visit( ) method that uses the Python match statement (Python 3.10 or newer) or any third-party library that achieves similar functionality.

TABLE 2
The visitor implementation.

```
class Visitor(BaseVisitor):
  def visit(self, node):
    # Iterate over all the classes in the MRO
    for name in (c._{——}name_{——}for c in node._{——}class_{——}._{——}mro_{——}):
      # Try to get the class-specific visitor method
      visitor = getattr(self, f‘visit_{name}’, None)
      if visitor is not None:
        try:
          # Call the visitor
          visitor(node)
        except ContinueVisit:
          # Visitor method rejected the node
          pass
        else:
          # Visitor method was successfully called
          break
    else:
      # Fallback on generic visit
      self.generic_visit(node)
    # Return initial node
    return node
  def generic_visit(self, node):
    # Visit all sub-nodes
    for n in node.nodes( ):
      self.visit(n)
```

The Transformer class uses the same type-matching algorithm as the Visitor class, but additionally allows modifications to nodes in the graph. If the returned node object is the same as the original node provided to the visit method, the node remains unchanged. If a different node object is returned, it will replace the original node. As a result of node immutability, visited nodes in the graph must be reconstructed if sub-nodes are modified. Hence, there is no generic visit method that accepts every type of node. Instead, the transformer class has two generic class specific visit methods for the Node and OperatorNode classes. These two fallback methods cover all node types and can reconstruct node objects if any sub-nodes are modified. The implementation of the Transformer class is shown in Table 3. To ensure nodes can be automatically reconstructed if sub-nodes are modified, class-specific visit methods for scalars and waveforms must return scalar and waveform nodes, respectively. A visit method for a waveform could theoretically return a scalar due to implicit type promotion, but the unconstrained duration could cause unintended side effects. In most cases, a clock waveform can not be replaced with another waveform type. If any transformation results in an illegal waveform or scalar, the transformer will fail and raise an exception.

TABLE 3
The transformer implementation.

```
class Transformer(BaseVisitor):
  def visit(self, node):
    # Iterate over all the classes in the MRO
    for name in (c._{——}name_{——}for c in node._{——}class_{——}._{——}mro_{——}):
      # Try to get the class-specific visitor method
      visitor = getattr(self, f‘visit_{name}’, None)
      if visitor is not None:
        try:
          # Call the visitor and return its result
          return visitor(node)
        except ContinueVisit:
          # Visitor method rejected the node
          pass
    # No matching visit method found
    raise ValueError
  def visit_Node(self, node):
    # Get the parameters of the node
    params = dict(node.params)
    if params:
      # Visit all sub-nodes
      new_params = {k: self.visit(n) for k, n in params.items( )}
      if params == new_params:
        # Sub-nodes remain unchanged, return the original node
        return node
      else:
        # Reconstruct the current node with new parameters
        return node._{——}class_{——}(**new_params)
    else:
      # Leaf nodes can always be returned immediately
      return node
  def visit_OperatorNode(self, node):
    # Get the items of the operator node
    items = list(node)
    # Visit all sub-nodes
    new_items = [self.visit(n) for n in items]
    if items == new_items:
      # Sub-nodes remain unchanged, return the original node
      return node
    else:
      # Reconstruct the current node with new items
      return node._{——}class_{——}(*new_items)
```

Several implementations of visitors and transformers are described below. The first two visitors are for substitution and clearing of variable scalars. The substitution visitor takes a single dictionary and uses it to call the substitute method of every variable in the graph. The clearing visitor calls the clear method of each variable instead. Another implementation of a visitor verifies that no waveform duration is negative to ensure waveforms or schedules are valid. Other common transformations cover the simplification of scalar and waveform graphs. Such transformations include variable substitution, folding, and operator simplification. Simplification transformations are most effective when all variables are substituted, but can also be effective with unsubstituted variables. Maximal munch visitors that can be used to transform the pulse representation into a linear data format. Maximal munch visitors often only match a sequence of specific sub-graphs supported by the target output, and any unmatched item causes an exception. A pattern mismatch indicates that the graph contains waveforms that are not supported by the target output. Hence, maximal munch visitors may perform the functions of both linearizing the data and verifying that waveforms are supported by the target.

In the implementation, the pipeline class contains a list of user-configurable visitor and transformation objects. Once the pipeline is configured, users can process a single waveform or a complete schedule using the pipeline. For a single waveform, the pipeline makes a deep copy of the visitor list and passes the waveform through all visitors. The pipeline returns a result object, which is a dataclass containing the final graph and the list of visitor objects used. Users can extract any information from the visitors and access the final graph if needed. When the pipeline processes a schedule, it returns a dictionary with channel objects and result objects as keys and values, respectively. The pipeline object makes a separate deep copy of the visitors for each channel. Finally, a user can provide a collection of channels if the user wants to apply the pipeline only to a subset of the channels in a schedule.

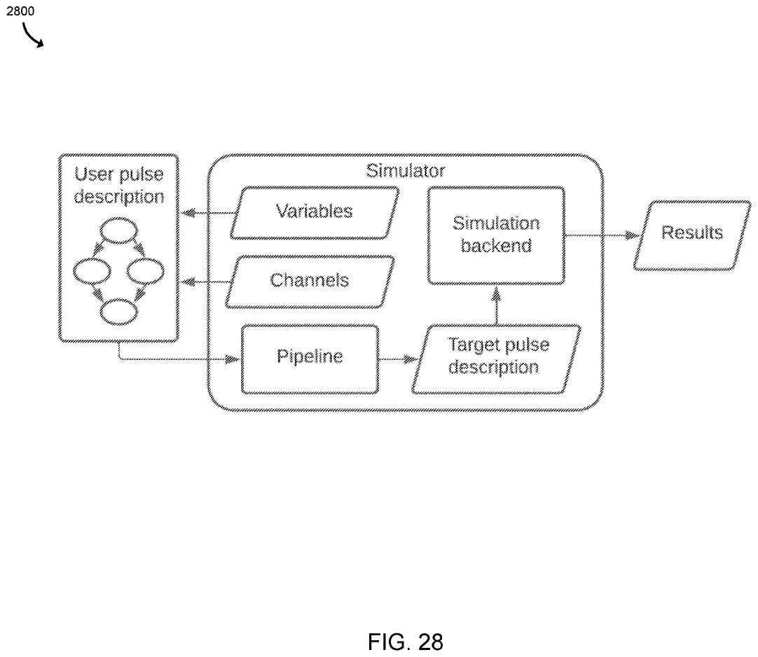

In the implementation, the architecture includes a library (e.g., the API 112) focused on the representation of pulses, and practical usage includes integration into real-time quantum control systems and simulators. Quantum simulators that accept pulse-level input (e.g. Hamiltonian-level simulators, such those based on QuTiP, QuantumOptics.jl, and IonSim.jl) can take schedule objects from the library as their input. The simulator provides channels and variables that can be used to create a schedule. The user-created schedule can be passed back to the simulator, which will pass it through a simulator-specific pipeline to obtain pulse descriptions in the desired format. Finally, the simulator can pass the pulse descriptions to the simulation backend to generate results for the user. A schematic overview 2800 of an embodiment of the library integration into a simulator is shown in FIG. 28.

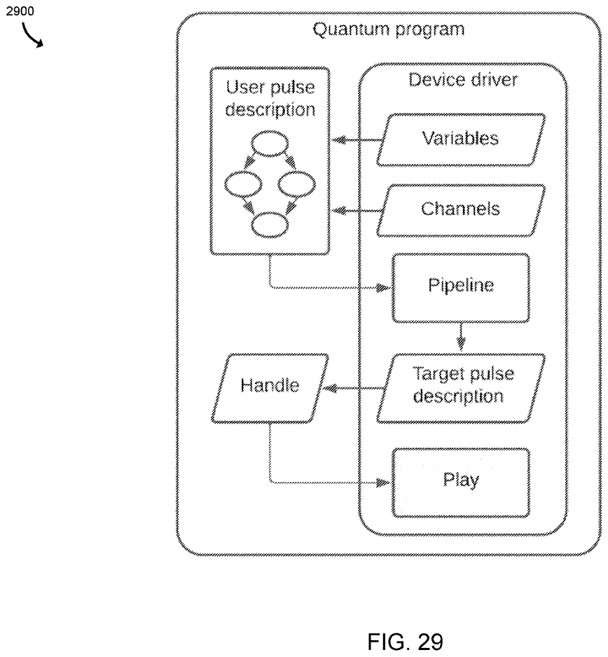

Quantum systems can provide pulse-level access to their real-time control systems using the library (e.g., the API 112). Such control systems may accept hybrid quantum programs as defined by an accelerator model. In the host-program part of the quantum program, users can create pulse schedules for specific target devices with the library using channels and variables provided by the device drivers. Channels might represent the target device on an abstract level, for example, global and individual beams for a trapped-ion system. Once a schedule is completed, the user can pass the schedule to the device driver, which will use a pipeline to transform the schedule to a device-specific format. For example, a direct digital synthesis (DDS) driver can convert the schedule to DDS parameters that can be sent to the device in real-time. The device driver can perform any additional device initialization if required, such as uploading waveform data to external RF equipment. The driver returns a handle that the user can store. Once the real-time kernel is running, the user passes the handle to the device driver to play the desired pulse schedule. During kernel execution, the execution of pulse schedules can be combined with classical operations and discrete quantum operations (e.g. state preparation and measurement) for classical and quantum complete kernels. A schematic overview 2900 of an embodiment of the library integration into a real-time quantum control system is shown in FIG. 29.

As described above, the architecture, efficiently stores high-level pulse descriptions in a graph-based format. The pulse representation supports arbitrary waveforms, but works most effectively with parameterized basic waveforms. Multi-channel pulse descriptions are supported by the channel and schedule infrastructure. Pulse descriptions can be transformed by applying recursive algorithms to the graph representation. Further, graph algorithms can be implemented using the visitor infrastructure using class and subclass-based type matching and pattern matching techniques. With the help of pipelines, pulse schedules can be transformed easily into linear data formats suitable for simulation or execution on a target device. These and other aspects enable the system 100 to be vastly more adaptable and efficient than conventional systems that tend to be usable only for specific target hardware, do not provide access to underlying waveform data, and do not enable integration with classical computing paradigms.

This disclosure is considered to be exemplary and not restrictive in character, and all changes and modifications that come within the spirit of the disclosure are desired to be protected. While particular aspects and embodiments are disclosed herein, other aspects and embodiments will be apparent to those skilled in the art in view of the foregoing teaching.

While the foregoing is directed to embodiments of the present disclosure, other and further embodiments of the disclosure may be devised without departing from the basic scope thereof, and the scope thereof is determined by the claims that follow.

1-102. (canceled)

103. A compute device comprising:
circuitry configured to:
obtain pulse description data indicative of a graph representing one or more parameters of at least one waveform that defines at least one pulse;
perform analysis operations on the graph to determine properties of the at least one pulse and produce a corresponding target pulse description based on the analysis; and
provide the target pulse description to a target application to produce the at least one pulse.

104. The compute device of claim 103, wherein to obtain pulse description data comprises to obtain pulse description data indicative of a directed acyclic graph of nodes and edges between the nodes by obtaining a directed acyclic graph with one or more regular nodes with labeled parameters and relations represented by labeled directed edges, and one or more operator nodes with an ordered set of items and relations represented by enumerated directed edges.

105. The compute device of claim 104, wherein to obtain pulse description data indicative of a directed acyclic graph comprises to obtain a directed acyclic graph with at least one node that represents a scalar.

106. The compute device of claim 104, wherein to obtain pulse description data indicative of a directed acyclic graph comprises to obtain a directed acyclic graph with at least one node that represents a waveform.

107. The compute device of claim 106, wherein to obtain a directed acyclic graph with at least one node that represents a waveform comprises to obtain a directed acyclic graph with a waveform node that has one or more sub-nodes indicative of parameters of the waveform.

108. The compute device of claim 104, wherein to obtain pulse description data indicative of a directed acyclic graph comprises to obtain a directed acyclic graph with at least one variable node that represents a variable that is not defined at the time the graph is constructed.

109. The compute device of claim 103, wherein to obtain pulse description data comprises to obtain pulse description data in which waveforms are assigned to channels in a schedule.

110. The compute device of claim 103, wherein to perform analysis operations on the graph comprises to substitute at least one variable represented by a node of the graph with a defined value.

111. The compute device of claim 103, wherein to perform analysis operations on the graph comprises to perform graph traversal operations.

112. The compute device of claim 103, wherein the circuitry is further configured to render at least one pulse sample.

113. The compute device of claim 103, wherein to perform analysis operations on the graph comprises to provide high-level data associated with the at least one pulse, the high-level data comprising a frequency, a frequency modulation, a duration, a phase, or a phase modulation of at least one waveform defining the at least one pulse.

114. The compute device of claim 103, wherein to provide the target pulse description to the target application comprises to provide at least one pulse sample to the target application.

115. The compute device of claim 103, wherein to provide the target pulse description to the target application comprises to provide a schedule that maps waveforms to channels associated with corresponding output devices.

116. The compute device of claim 103, wherein to provide the target pulse description to the target application comprises to provide direct digital synthesis parameters to the target application.

117. The compute device of claim 103, wherein to provide the target pulse description to the target application comprises to provide the target pulse description to a radio frequency (RF) controller.

118. A method comprising:
obtaining, by a compute device, pulse description data indicative of a graph representing one or more parameters of at least one waveform that defines at least one pulse;
performing, by the compute device, analysis operations on the graph to determine properties of the at least one pulse and produce a corresponding target pulse description based on the analysis; and
providing, by the compute device, the target pulse description to a target application to produce the at least one pulse.

119. The method of claim 118, wherein obtaining pulse description data comprises obtaining pulse description data indicative of a directed acyclic graph of nodes and edges between the nodes by obtaining a directed acyclic graph with one or more regular nodes with labeled parameters and relations represented by labeled directed edges, and one or more operator nodes with an ordered set of items and relations represented by enumerated directed edges.

120. The method of claim 118, wherein obtaining pulse description data comprises obtaining pulse description data in which waveforms are assigned to channels in a schedule.

121. The method of claim 118, further comprising rendering, by the compute device, at least one pulse sample.

122. The method of claim 118, wherein performing analysis operations on the graph comprises providing high-level data associated with the at least one pulse, the high-level data comprising data indicative of a frequency, a frequency modulation, a duration, a phase, or a phase modulation of at least one waveform defining the at least one pulse.
